(19) United States
(12) Patent Application Publication
(10) Pub. No.: US 2025/0338851 A1
(43) Pub. Date: Nov. 6, 2025

(54) Boosted IPBC for Wet-State Bacterial Control

(71) Applicant: Troy Technology II, Inc., Florham Park, NJ (US)

(72) Inventors: Ashley Gil, Florham Park, NJ (US); Meihua Yang, Florham Park, NJ (US); Chun-Kai Yang, Florham Park, NJ (US); Jake Jacobs, Florham Park, NJ (US)

(21) Appl. No.: 18/561,936

(22) PCT Filed: May 20, 2022
(86) PCT No.: PCT/US2022/030281

§ 371 Date: Nov. 17, 2023

Related U.S. Application Data
(60) Provisional application No. 63/191,612, filed on May 21, 2021.
(60) Provisional application No. 63/332,344, filed on Apr. 19, 2022.

(51) Int. Cl. A01N 59/16; A01N 31/02; A01N 47/12; A01P 1/00

(52) U.S. Cl. CPC A01N 59/16; A01N 31/02; A01N 47/12; A01P 1/00

(57) ABSTRACT

A biocidal composition, comprising an antibacterially effective combination of IPBC, zinc oxide, and bacterial membrane disrupting substances, and a working composition comprising water, one or more organic compounds, and a biocidal composition comprising IPBC, zinc oxide, and a bacterial membrane disrupting substance, effective for wet-state and dry-film preservation of the working composition. Also, a method of enhancing antibacterial activity of IPBC in a wet-state working composition comprising water and one or more organic compounds, comprising treating the working composition with IPBC in the presence of zinc oxide and bacterial membrane disrupting substances, and a method of treating an aqueous working formulation containing one or more organic compounds, to prevent, inhibit, or reduce wet-state bacterial contamination of the formulation, comprising treating the working formulation with a biocidal composition comprising an antibacterially effective combination of IPBC, zinc oxide, and a bacterial membrane disrupting substance.

### RELATED APPLICATIONS

The present application is the U.S. National Stage entry of International Application Number PCT/US2022/030281 filed under the Patent Cooperation Treaty having a filing date of May 20, 2022, which claims priority to U.S. Provisional Patent Application Ser. No. 63/191,612 filed on May 21, 2021 and U.S. Provisional Patent Application Ser. No. 63/332,344 filed on Apr. 19, 2022, which are incorporated herein by reference.

### BACKGROUND

Iodopropynyl butylcarbamate (IPBC) is an industrially important fungicide recognized for its broad-spectrum activity against fungal organisms, but large gaps in efficacy against bacterial species. It is widely understood in the industry that IPBC can only control the growth of select bacteria. In particular, species in the genus Pseudomonas are particularly known for their resistance to treatment with IPBC. As a result, coatings producers, for example, have had to use a number of biocide products in order to achieve adequate protection of coating compositions against microbial attack in both the wet state and the dry film state. At present, coatings producers need to separately purchase and formulate at least two types of biocidal ingredients, a wet state preservative and a dry film preservative.

Accordingly, there remains a need for biocidal compositions that, as a single product, provide adequate protection of coating compositions and other working compositions against a wide range of microbiological hazards (i.e., a single product that when formulated into a coating or working composition simultaneously prevents or retards microbiological growth both when the composition is in the wet state as well as when it has been converted into a dry film), in particular against both wet state (e.g., in-can) bacterial and fungal attack and dry film state fungal and/or algal attack. Further, due to global regulatory pressures to reduce or eliminate the use of sensitizing and CMR preservatives, there exists a need for these biocidal compositions to be free of isothiazolinones, pyrithiones, and formaldehydes.

### SUMMARY

The present disclosure provides a single biocidal product comprising the biocide iodopropynyl butylcarbamate (IPBC) that is capable of imparting a sufficient level of protection to an aqueous working composition containing one or more organic compounds, in particular to coating compositions such as paints and colorants, and to joint compound, both in the wet state and as a dry film, against a broad range of organism types (bacteria, fungi). Through the use of the inventive biocidal compositions described herein, the need to formulate a coating composition using multiple sources of different biocides may be avoided. That is, adequate wet state and dry film state resistance to biological attack of a coating composition, and in particular bacterial attack in the wet state, may be attained, without the addition of any other biocide-containing ingredient to the coating composition.

According to the present disclosure, zinc oxide enhances the bactericidal activity of IPBC in aqueous compositions, and the combination of IPBC and zinc oxide acts synergistically. The combination of IPBC and zinc oxide achieves strong and unexpected kill activities against IPBC resistant bacteria (like Pseudomonas). The combination of IPBC and zinc oxide further with 1,2-hexanediol is unexpectedly and exceptionally effective at controlling wet state bacterial growth, repurposing the fungicide IPBC to kill bacteria in the wet state without losing its dry film activity. The biocidal compositions of the present disclosure represent a significant advancement and fill an important market need for isothiazolinone, pyrithione, and formaldehyde-free in-can and dry-film preservation.

A biocidal composition in accordance with the present disclosure thus provides the following practical advantages, as compared to the conventional use in the coatings industry of separate wet-state and dry-film preservative packages:
i) Reduced cost to the end user (coatings formulator);
ii) Fewer different inventory items for the end user to purchase, store and maintain;
iii) Operational simplicity, with only one biocide-containing product to be metered into a coating composition rather than several;
iv) Lessened environmental impact, due to the lower energy usage arising from manufacturing, packaging and transporting a single biocide-containing product rather than several; and
v) Favorable regulatory impact on end-use products by being free of isothiazolinone, pyrithione, and formaldehyde.

Various example aspects of the disclosure may be summarized as follows.

Aspect 1: A biocidal composition, comprising an antibacterially effective combination of IPBC and zinc oxide.

Aspect 2: The biocidal composition of Aspect 1, wherein the IPBC and zinc oxide are present in a weight ratio of 25:1 to 1:25.

Aspect 3: The biocidal composition of Aspects 1 or 2, wherein the zinc oxide comprises zinc oxide nanoparticles.

Aspect 4: The biocidal composition of Aspects 1-3, further comprising one or more bacterial membrane disrupting substances.

Aspect 5: The biocidal composition of Aspects 1-4, wherein the one or more bacterial membrane disrupting substances comprise one or more vicinal diols.

Aspect 6: The biocidal composition of Aspects 1-5, wherein the one or more vicinal diols comprise 1,2-hexanediol.

Aspect 7: The biocidal composition of Aspects 4-7, wherein the one or more bacterial membrane disrupting substances comprise one or more glycol ethers.

Aspect 8: The biocidal composition of Aspects 1-7, wherein the one or more bacterial membrane disrupting substances comprise hexyl carbitol, TPnB glycol ether, butoxytrigycol, or triacetin.

Aspect 9: The biocidal composition of Aspects 1-8, further comprising one or more additional biocidal substances.

Aspect 10: The biocidal composition of Aspects 1-9, wherein the one or more additional biocidal substances comprise one or more antifungal substances and/or one or more algaecidal substances.

Aspect 11: The biocidal composition of Aspects 1-10, comprising 1% to 25% by weight IPBC, 1% to 25% by weight zinc oxide, and 40% to 80% by weight of one or more vicinal diols.

Aspect 12: The biocidal composition of Aspects 1-11, comprising 10% by weight IPBC, 5% by weight zinc oxide, and 60% by weight of one or more vicinal diols.

Aspect 13: The biocidal composition of Aspect 7, comprising 1% to 25% by weight IPBC, 1% to 25% by weight zinc oxide, and 40% to 80% by weight of the one or more glycol ethers.

Aspect 14: The biocidal composition of Aspects 1-13, comprising about 10% by weight IPBC, about 5% by weight zinc oxide, and about 60% by weight of the one or more glycol ethers.

Aspect 15: A working composition comprising water, one or more organic compounds, and a biocidal composition comprising IPBC and zinc oxide effective for wet-state anti-bacterial preservation of the working composition.

Aspect 16: The working composition of Aspect 15, wherein the IPBC and zinc oxide are present in a weight ratio of 25:1 to 1:25.

Aspect 17: The working composition of Aspect 15 or 16, wherein the zinc oxide comprises zinc oxide nanoparticles.

Aspect 18: The working composition of Aspects 15-17, wherein the biocidal composition further comprises one or more bacterial membrane disrupting substances.

Aspect 19: The working composition of Aspect 18, wherein the one or more bacterial membrane disrupting substances comprise one or more vicinal diols.

Aspect 20: The working composition of Aspect 18 or 19, wherein the one or more vicinal diols comprise 1,2-hexanediol.

Aspect 21: The working composition of Aspect 18, wherein the one or more bacterial membrane disrupting substances comprise one or more glycol ethers.

Aspect 22: The working composition of Aspect 21, wherein the one or more bacterial membrane disrupting substances comprise hexyl carbitol, TPnB glycol ether, butoxytrigycol or triacetin.

Aspect 23: The working composition of Aspects 15-22, further comprising one or more additional biocidal substances.

Aspect 24: The working composition of Aspect 23, wherein the one or more additional biocidal substances comprise one or more antifungal substances and/or one or more algaecidal substances.

Aspect 25: The working composition of Aspects 15-19, wherein the biocidal composition comprises 1% to 25% by weight IPBC, 1% to 25% by weight zinc oxide, and 40% to 80% by weight of one or more vicinal diols.

Aspect 26: The working composition of Aspect 26, wherein the biocidal composition comprises 10% by weight IPBC, 5% by weight zinc oxide, and 60% by weight of the one or more vicinal diols.

Aspect 27: The working composition of Aspects 15-21, comprising 1% to 25% by weight IPBC, 1% to 25% by weight zinc oxide, and 40% to 80% by weight of one or more glycol ethers.

Aspect 28: The working composition of Aspect 27, comprising about 10% by weight IPBC, about 5% by weight zinc oxide, and about 60% by weight of one or more glycol ethers.

Aspect 29: The working composition of Aspects 15-28, wherein the one or more organic compounds comprise one or more polymeric binders or fillers.

Aspect 30: The working composition of Aspects 15-29, comprising a cosmetic, toiletry, personal care, household, laundry, cleaning, disinfecting, paint, coating, mineral slurry, pigment, pulp slurry, paper slurry, paper, metal working fluid, construction, plant nutrient, polymer lattice, wallboard joint compound, wallboard, spackling, sealant, stucco, mastic, asphalt emulsion, wood preservative, lazure, stain, plaster, adhesive, textile, leather treatment, hide treatment, non-woven fabric, building material, stucco, concrete, or caulk product.

Aspect 31: The working composition of Aspects 15-29, wherein the one or more polymeric binders or fillers comprise one or more acrylate, butadiene, PVA, EVA, styrene, or vinyl acetate polymers.

Aspect 32: A method of enhancing antibacterial activity of IPBC in a wet-state working composition comprising water and one or more organic compounds, comprising treating the working composition with IPBC in the presence of zinc oxide.

Aspect 33: The method of Aspect 32, wherein the IPBC and zinc oxide are present in a weight ratio of 25:1 to 1:25.

Aspect 34: The method of Aspects 32 or 33, wherein the zinc oxide comprises zinc oxide nanoparticles.

Aspect 35: The method of Aspects 32-34, wherein the working composition is further treated with one or more bacterial membrane disrupting substances.

Aspect 36: The method of Aspects 32-35, wherein the one or more bacterial membrane disrupting substances comprise one or more vicinal diols.

Aspect 37: The method of Aspect 36, wherein the one or more vicinal diols comprise 1,2-hexanediol.

Aspect 38: The method of Aspects 32-35, wherein the one or more bacterial membrane disrupting substances comprise one or more glycol ethers.

Aspect 39: The method of Aspect 38, wherein the one or more bacterial membrane disrupting substances comprise hexyl carbitol, TPnB glycol ether, butoxytrigycol or triacetin.

Aspect 40: The method of Aspects 32-29, wherein the working composition is further treated with one or more additional biocidal substances.

Aspect 41: The method of Aspects 32-40, wherein the one or more additional biocidal substances comprise one or more antifungal substances and/or one or more algaecidal substances.

Aspect 42: The method of Aspects 32-41, comprising treating the working composition with a wet-state antibacterially effective amount of a biocidal composition comprising 1% to 25% by weight IPBC, 1% to 25% by weight zinc oxide, and 40% to 80% by weight of one or more vicinal diols.

Aspect 43: The method of Aspects 32-42, wherein the biocidal composition comprises 10% by weight IPBC, 5% by weight zinc oxide, and 60% by weight of the one or more vicinal diols.

Aspect 44: The method of Aspects 32-43, comprising 1% to 25% by weight IPBC, 1% to 25% by weight zinc oxide, and 40% to 80% by weight of one or more glycol ethers.

Aspect 45: The method of Aspects 32-44, comprising about 10% by weight IPBC, about 5% by weight zinc oxide, and about 60% by weight of one or more glycol ethers.

Aspect 46: A method of treating an aqueous working formulation containing one or more organic compounds, to prevent, inhibit, or reduce wet-state bacterial contamination of the formulation, comprising treating the working formulation with a biocidal composition comprising an antibacterially effective combination of IPBC and zinc oxide.

Aspect 47: The method of Aspect 46, wherein the IPBC and zinc oxide are present in a weight ratio of 25:1 to 1:25.

Aspect 48: The method of Aspects 46 or 47, wherein the zinc oxide comprises zinc oxide nanoparticles.

Aspect 49: The method of Aspects 46-48, further comprising treating the working formulation with one or more bacterial membrane disrupting substances.

Aspect 50: The method of Aspects 46-49, wherein the one or more bacterial membrane disrupting substances comprise one or more vicinal diols.

Aspect 51: The method of Aspect 50, wherein the one or more vicinal diols comprise 1,2-hexanediol.

Aspect 52: The method of Aspects 46-49, wherein the one or more bacterial membrane disrupting substances comprise one or more glycol ethers.

Aspect 53: The method of Aspects 46-52, wherein the one or more bacterial membrane disrupting substances comprise hexyl carbitol, TPnB glycol ether, butoxytrigycol or triacetin.

Aspect 54: The method of Aspects 46-53, further comprising treating the working formulation with one or more additional biocidal substances.

Aspect 55: The method of Aspects 46-54, wherein the one or more additional biocidal substances comprise one or more antifungal substances and/or one or more algaecidal substances.

Aspect 56: The method of Aspects 46-50, comprising treating the working formulation with a biocidal composition comprising 1% to 25% by weight IPBC, 1% to 25% by weight zinc oxide, and 40% to 80% by weight of one or more vicinal diols.

Aspect 57: The method of Aspects 46-56, wherein the biocidal composition comprises 10% by weight IPBC, 5% by weight zinc oxide, and 60% by weight of the one or more vicinal diols.

Aspect 58: The method of Aspects 46-52, comprising 1% to 25% by weight IPBC, 1% to 25% by weight zinc oxide, and 40% to 80% by weight of one or more glycol ethers.

Aspect 59: The method of Aspects 46-58, comprising about 10% by weight IPBC, about 5% by weight zinc oxide, and about 60% by weight of one or more glycol ethers.

Aspect 60: The method of Aspects 46-59, wherein the one or more organic compounds comprise one or more polymeric binders or fillers.

Aspect 61: The method of Aspects 46-60, wherein the working composition comprises a cosmetic, toiletry, personal care, household, laundry, cleaning, disinfecting, paint, coating, mineral slurry, pigment, pulp slurry, paper slurry, paper, metal working fluid, construction, plant nutrient, polymer lattice, wallboard joint compound, wallboard, spackling, sealant, stucco, mastic, asphalt emulsion, wood preservative, lazure, stain, plaster, adhesive, textile, leather treatment, hide treatment, non-woven fabric, building material, stucco, concrete, or caulk product.

Aspect 62: The method of Aspect 60, wherein the one or more polymeric binders or fillers comprise one or more acrylate, butadiene, PVA, EVA, styrene, or vinyl acetate polymers.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 depicts growth curves of Pseudomonas aeruginosa (ATCC #10145) in the presence of 0.125-0.5 mM PAβN with and without IPBC;

FIG. 2 depicts growth curves of Pseudomonas aeruginosa (ATCC #10145) with and without nanoparticle ZnO and a checkerboard assay with varying levels of IPBC and nanoparticle ZnO;

FIG. 3 depicts kill curves for Pseudomonas aeruginosa (ATCC #10145) IPBC and ZnO;

FIG. 4 depicts the effect of 1,2-hexanediol on membrane permeability of Pseudomonas aeruginosa (ATCC #10145);

FIG. 5 depicts kill curves for Pseudomonas aeruginosa (ATCC #10145) against the combination of IPBC, ZnO, and 1,2-hexanediol at sub-inhibitory concentrations of 1,2-hexanediol;

FIG. 6 is a plot of synergy index (S.I.) for a preferred inventive composition (“Omniphase Z”) versus minimum inhibitory concentration (MIC) for IPBC against a variety of microbes;

FIG. 7 depicts comparative challenge testing results in joint compound and paint against a variety of microbes;

FIG. 8 depicts comparative dry-film bacterial resistance testing results in paint;

FIG. 9 depicts the effect of 1,2-hexanediol, 1,2-octanediol, texanol, and diverse glycol ethers on membrane permeability of Pseudomonas aeruginosa (ATCC #10145);

FIG. 10 depicts a ROC curve showing the relationship between the degree of membrane permeabilization caused by various solvents and their ability to preserve paint containing IPBC/ZnO;

FIG. 11 depicts kill curves for Pseudomonas aeruginosa (ATCC #10145) Omniphase Z formulated with Hexyl Carbitol (“1750-8”); and

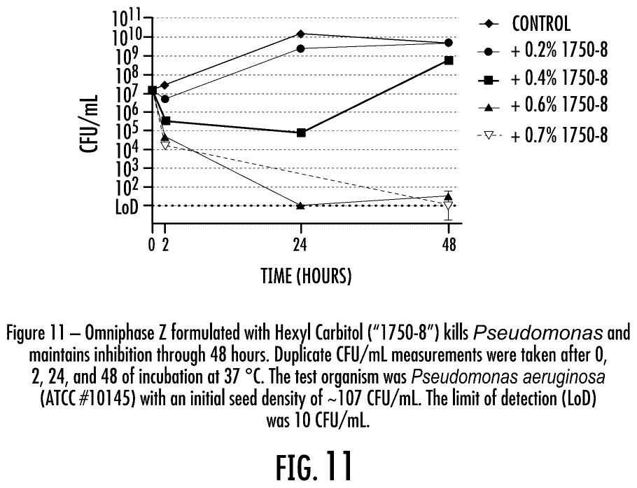

FIG. 12 is a plot of synergy index (S.I.) for Omniphase Z prepared with Hexyl Carbitol (“1750-8”) versus minimum inhibitory concentration (MIC) for IPBC against a variety of microbes.

Repeat use of reference characters in the present specification and drawings is intended to represent the same or analogous features or elements of the present disclosure.

### DETAILED DESCRIPTION

It is to be understood by one of ordinary skill in the art that the present discussion is a description of exemplary embodiments only, and is not intended as limiting the broader aspects of the present disclosure.

IPBC's spectrum of activity against diverse bacterial species in working compositions is expanded by the presence of zinc oxide. Further combination with 1,2-hexanediol significantly boosted the activity of ZnO/IPBC in paint, colorant, and joint compound, and significantly outperformed 1,2-hexanediol, IPBC, and combinations of IPBC and 1,2-hexanediol in wet-state bacterial challenge testing. A formulation containing 10% IPBC, 5% ZnO, and 60% 1,2-hexanediol was prepared and tested in a variety of matrices and shown to have broad spectrum wet state bacterial and fungal control properties in colorants, paints, and joint compound, and dry film fungal and bacterial control properties in paint. The biocidal compositions of the present disclosure are a significant advancement and fill an important market need for isothiazolinone, pyrithione, and formaldehyde-free in-can and dry-film preservation.

### IPBC

The biocidal compositions of the present disclosure contain 3-iodoprop-2-yn-1-yl butylcarbamate (CAS No. 55406-53-6, at times referred to herein as “IPBC”). IPBC is sometimes alternatively referred to as 3-iodo-2-propynyl N-butylcarbamate, 3-iodo-2-propynyl butylcarbamate, iodopropynyl butylcarbamate, or iodocarb. IPBC is present in the biocidal compositions in an amount of 1% to 25% by weight, 5% to 20% by weight, 5% to 15% by weight, or about 10% by weight, based on the weight of the composition.

### Zinc Oxide

The biocidal compositions of the present disclosure also contain zinc oxide (at times referred to herein as “ZnO”). Preferably, the zinc oxide comprises a zinc oxide particle size less than 50 microns. The zinc oxide may also be present as nano-particles. Zinc oxide is present in the biocidal compositions in an amount of 1% to 25% by weight, 2% to 20% by weight, 3% to 15% by weight, 4% to 10% by weight, or about 5% by weight, based on the weight of the composition. The weight ratio of IPBC to ZnO should be controlled to be within the range of from 25:1 to 1:25, limits included. In various aspects of the disclosure, the weight ratio of IPBC to ZnO in the biocidal compositions of the disclosure is 20:1 to 1:20, 15:1 to 1:15, 10:1 to 1:10, 5:1 to 1:5, or 4:1 to 1:4. In another aspect, the weight ratio of IPBC to ZnO is 2:1.

### Membrane Disrupting Substances

The biocidal compositions of the present disclosure optionally contain one or more substances capable of disrupting microbial membranes, in particular bacterial membranes. The boosting of IPBC/ZnO activity may be linked to membrane permeabilization. For instance, the degree of permeabilization caused by a bacterial membrane disrupting substance is correlated to the ability of the membrane disrupting substance to boost IPBC/ZnO antibacterial performance in the coating compositions.

In various aspects of the disclosure, the membrane disrupting substance comprises one or more vicinal diols. Vicinal diols useful in various aspects of the disclosure include 1,2-hexanediol, including propanediol, methylpropanediol, butylene glycol, 1,2-pentanediol, caprylyl glycol, 1,2-decanediol, caprylyl glyceryl ether, ethylhexylglycerin, glyceryl monolaurate, glyceryl monocaprate, glyceryl monocaprylate, and combinations thereof. In further aspects of the disclosure, the one or more vicinal diols include 1,2-hexanediol (CAS No. 6920-22-5, also known as DL-1,2-Hexanediol, 1,2-Dihydroxyhexane, dl-hexane-1,2-diol, or 5,6-Dihydroxyhexane). Further, in various aspects disclosed herein, the membrane disrupting substance comprises one or more glycol ethers. Glycol ethers useful in various aspects disclosed herein may include Hexyl Carbitol, Hexyl CELLOSOLVE™, Butyl CELLOSOLVE™, and Ethoxytriglycol, DOWANOL™ Eph6 Glycol Ether (polyethylene glycol phenyl ether), UCAR™ Filmer IBT (2,2,4-trimethyl-1,3-pentanediol monoisobutyrate), DOWANOL™ LoV 485 Glycol Ether (bis-dipropylene glycol n-butyl ether adipate), DOWANOL™ TPnB Glycol Ether (tripropylene glycol n-propyl ether), DOWANOL™ PnP Glycol Ether (propylene glycol n-propyl ether), Butoxytriglycol, Arcosolv PnB (1-butoxy-2-propanol), Texanol, or a combination thereof.

The one or more vicinal diols are present in the biocidal composition of the disclosure in an amount of 40% to 80% by weight of the composition. In various aspects of the disclosure, the one or more vicinal diols are present in the biocidal composition of the disclosure in an amount of about 60% by weight of the composition. In another aspect, the weight ratio of IPBC to zinc oxide to vicinal diol(s) is 10:5:60 (2:1:12). A preferred biocidal composition of the disclosure comprises 1% to 25% by weight IPBC, 1% to 25% by weight zinc oxide, and 40-80% by weight 1,2-hexanediol, based on the weight of the biocidal composition. A particularly preferred biocidal composition of the disclosure comprises 10% by weight IPBC, 5% by weight zinc oxide, and 60% by weight 1,2-hexanediol, based on the weight of the biocidal composition.

The one or more glycol ethers are present in the biocidal composition of the disclosure in an amount of 40% to 80% by weight of the composition. In various aspects of the disclosure, the one or more glycol ethers are present in the biocidal composition of the disclosure in an amount of about 60% by weight of the composition. In another aspect, the weight ratio of IPBC to zinc oxide to glycol ether(s) is 10:5:60 (2:1:12). A preferred biocidal composition of the disclosure comprises 1% to 25% by weight IPBC, 1% to 25% by weight zinc oxide, and 40-80% by weight hexyl carbitol, based on the weight of the biocidal composition. A particularly preferred biocidal composition of the disclosure comprises 10% by weight IPBC, 5% by weight zinc oxide, and 60% by weight hexyl carbitol, based on the weight of the biocidal composition.

### Biocides

One or more other biocides may be present in the biocidal compositions of the present disclosure, in addition to the IPBC. In one aspect, the biocidal composition of the disclosure contains no additional biocides. In another aspect, the additional biocide or biocides comprise one or more antifungal and/or algaecidal biocides. The one or more additional biocides may comprise methylbenzimidazole-2-yl carbamate (“BCM”) and/or 3-(3,4-dichlorphenyl)-1,1-dimethylurea (“Diuron”). Other biocides which may be present in the biocidal compositions of the disclosure include, but are not limited to, any of the biocidal compounds known in the art. Supplemental wet-state actives that can be used include, but are not limited to, 5-chloro-2-methyl-2H-isothiazol-3-one/2-methyl-2H-isothiazol-3-one (“CMIT/MIT”) and 2-bromo-2-nitropropane-1,3-diol (“Bronopol”). Supplemental algaecides that can be used include, but are not limited to, 2-tert-Butylamino-4-ethylamino-6-methylthio-1,3,5-triazin (“Terbutryn”) and 3-(4-isopropylphenyl)-1,1-dimethylurea (“Isoproturon”).

It will be advantageous for any biocide present in the biocidal composition to be in the form of relatively fine particles, for example, particles having a particle size of from 5 to 75 microns. The desired particle size may be attained with conventional techniques such as grinding, milling, sieving and the like.

### Surfactants

The biocidal compositions of the present disclosure may utilize one or more surfactants. The surfactants function as emulsifiers and help to keep the water-insoluble components of the formulation in the form of a stable dispersion (emulsion) of small particles suspended in an aqueous phase.

Suitable types of nonionic surfactants include, but are not limited to, polyoxyalkylene glycol alkyl ethers (e.g., polyoxyethylene glycol alkyl ethers, polyoxypropylene alkyl ethers, polyoxyethylene/propylene alkyl ethers), glucoside alkyl ethers, polyoxyalkylene glycol alkylphenol ethers (e.g., polyoxyethylene glycol alkylphenol ethers, polyoxypropylene glycol alkylphenol ethers, polyoxyethylene/propylene glycol alkylphenol ethers), glycerol alkyl esters, polyoxyalkylene glycol sorbitan alkyl esters (e.g., polyoxyethylene glycol sorbitan alkyl esters), sorbitan alkyl esters, cocamide MWA, cocamide DEA, block copolymers of polyethylene glycol and polypropylene glycol (poloxamers), polyalkoxylated tallow amines, alkoxylated fatty acids and the like and combinations thereof.

Particular nonionic surfactants include alkoxylated aliphatic mono-alcohols and alkoxylated aromatic mono-alcohols. Such surfactants are typically prepared by reacting one or more alkylene oxides (e.g., ethylene oxide, propylene oxide, mixtures of ethylene oxide and propylene oxide) with one or more mono-alcohols (e.g., aliphatic alcohols, which may be for example linear or branched, primary or secondary, or aromatic alcohols, such as phenols, including alkyl- and aralkyl-substituted phenols). The number of moles of alkylene oxide reacted per mole of the mono-alcohol may be varied as may be desired, but typically is from about 2 to about 50 on average. If more than one type of alkylene oxide is used, the alkylene oxides may be reacted as a mixture (to provide a polyoxyalkylene segment having a random copolymer structure) or sequentially (to provide a polyoxyalkylene segment having a block copolymer structure).

Another type of nonionic surfactant for use in the present disclosure is an alkoxylated aliphatic mono-alcohol which is an ethoxylated C₁₀-C₁₈ aliphatic alcohol (in particular, a linear primary C₁₂-C₁₆ aliphatic alcohol (or mixture of such alcohols) which has been reacted with about 6 to about 15 moles of ethylene oxide per mole of aliphatic alcohol to provide an alkoxylated alcohol containing an average of about 6 to about 15 oxyethylene repeating units per molecule). For example, the alkoxylated aliphatic mono-alcohol may be an ethoxylated C₁₂-C₁₆ linear aliphatic alcohol containing an average of about 8 to about 12 ethylene oxide units per molecule. In particular, ethoxylated tridecanol containing an average of about 10 ethylene oxide units is suitable for use in the present disclosure.

Another type of nonionic surfactant for use in the present disclosure is an alkoxylated C₂-C₈ aliphatic alcohol containing both ethylene oxide and propylene oxide units. The C₂-C₈ aliphatic alcohol may be n-butanol, for example. The ethylene oxide and propylene units may be arranged in a block manner (e.g., the surfactant may contain a polyoxyethylene block and a polyoxypropylene block). Also suitable for use as nonionic surfactants are alkoxylated phenols, in particular ethoxylated phenols wherein the phenol may be substituted with one or more alkyl groups (in particular, long chain alkyl groups such as nonyl or dodecyl groups or aralkyl groups, such as in tristyrylphenol).

Suitable anionic surfactants include, but are not limited to, surfactants containing anionic functional groups at their head, such as sulfate groups, sulfonate groups, phosphate groups, and carboxylate groups. The cationic counterion to the anionic functional group may be, for example, an alkali metal (e.g., Na, K) or an amine (ammonium) cation such as a quaternary ammonium. Useful types of anionic surfactants in the present disclosure include, but are not limited to, alkyl sulfates, alkyl ether sulfates, sulfated alkanolamides, glyceride sulfates, alkyl aryl sulfonates (including straight-chain alkylbenzenesulfonates, branched alkylbenzenesulfonates, alkylnaphthalene-sulfonates), alpha olefin sulfonates, lignosulfonates, sulfo-carboxylic compounds (e.g., sodium lauryl sulfoacetate, sulfosuccinates (including dialkylsulfosuccinates), sulfosuccinamates, organo phosphored surfactants, sacrosides, hydroxyalkane-sulfonates, alkanesulfonates, alkylphenoxy polyoxyethylene propyl sulfonates, salts of polyoxyethylene alkylsulfophenyl ethers, sodium N-methyl-N-oleyltaurates, monoamide disodium N-alkylsulfosuccinates, petroleum sulfonates, sulfated castor oil, sulfated tallow oil, salts of sulfuric esters of aliphatic alkylesters, salts of alkylsulfuric esters, salts of alkylsulfuric esters, sulfuric esters of polyoxyethylenealkylethers, salts of sulfuric esters of aliphatic monoglycerides, sodium salt of the monosulfated monoglyceride of hydrogenated coconut oil fatty acids, salts of sulfuric esters of polyoxyethylene alkylphenylethers, salts of alkylphosphoric esters, salts of phosphoric esters of polyoxyethylenealkylethers, salts of phosphoric esters of polyoxyethylenealkylphenylethers, partially saponified compounds of styrene-maleic anhydride copolymers, partially saponified compounds of olefin-maleic anhydride copolymers, naphthalenesulfonate-formalin condensates, higher alkyl sulfoacetates, and higher fatty acid esters of 1,2-dihydroxy propane sulfonate and combinations thereof. Particular among these anionic surfactants are sulfonate surfactants, in particular salts of alkyl aryl sulfonates, especially salts of C₈-C₁₈ alkyl benzene sulfonates such as salts of dodecylbenzene sulfonate, and combinations thereof.

A total amount of surfactant is used that is effective, in combination with the any thickeners and/or suspending agent that may be present in the composition, to provide a physically stable dispersion. The amount of surfactant needed to achieve a physically stable dispersion will depend on a number of factors, including, for instance, the types and amounts of biocides and thickeners/suspending agents present and well as the types of surfactants utilized. Typically, however, an amount of surfactant is used which is sufficient to provide a weight ratio of biocide:surfactant within the range of from about 5:1 to about 50:1 or from about 6:1 to about 20:1.

Further, certain surfactants and combinations of surfactants also have well-known activities disrupting membranes. This activity is general to several cationic surfactants, but is also true of certain non-ionic and ionic surfactants.

### Thickeners Suspending Agents

The biocidal compositions of the present disclosure may include one or more substances capable of functioning as thickener or suspending agents to render the biocidal compositions physically stable. In particular, the types and amounts of thickeners and/or suspending agents are selected such that at 25° C. the resulting biocidal composition has a viscosity of at least 300 cps. In other embodiments, the viscosity of the biocidal composition at 25° C. is at least 400 cps or at least 500 cps. Generally, it will be desirable for the viscosity of the biocidal composition to not be increased to the point where it becomes difficult to transfer or handle the biocidal composition by means of pumping. Viscosity is measured using a Brookfield viscometer (spindle #5, 100 rpm).

Suitable thickeners/suspending agents include, without limitation, clays (including natural clays and organo-modified clays), silicates (e.g., silicas such as modified silicas and fumed silicas), polysaccharides (e.g., gums such as xanthan gum, cellulosic polymers), polyacrylates, and the like and combinations thereof.

### Optional Additional Ingredients

One or more other components, in addition to those mentioned above, may additionally be present in the biocidal compositions of the present disclosure. In certain embodiments, however, the biocidal composition consists essentially of or consists of only the aforementioned components, except that one or more defoamers may optionally be present in such embodiments.

Optional additional components include, but are not limited to, dispersants, defoamers (antifoams, e.g., silicone-based defoamers, mineral oil-based defoamers, hydrophobic silica-based defoamers), sequestering/chelating agents, pH adjusting agents, fillers, coloring agents, antifreezing agents, corrosion inhibitors (anti-corrosion additives), ultraviolet light stabilizers, antioxidants, solvents, co-solvents, scale inhibitors, and the like.

### Methods of Making

Biocidal compositions in accordance with the present disclosure may be prepared by adaptation of any of the techniques known in the art for creating dispersions of water-insoluble substances in water using surfactants (emulsifiers), thickeners, suspending agents, and combinations of these ingredients. For example, a suitably sized mixing vessel may be charged with water, followed by the surfactants desired to be included in the biocidal composition. While agitating the surfactant/water mixture, the biocides and a portion of the thickeners/suspending agents are added. Mixing at high speed and/or high shear may be continued until a homogeneous emulsion having the desired particle size (typically 5 to 75 microns) is obtained. The mixture may be heated to a temperature somewhat above room temperature during this step. The remaining thickeners/suspending agents may then be added and the mixture agitated until homogeneous once again. The mixture may be cooled to room temperature prior to the final addition of thickeners/suspending agents. The biocidal composition may then be transferred by pumping or other means to one or more suitable storage containers such as tanks, drums or totes.

### Working Compositions

The biocidal compositions of the present disclosure are useful for imparting resistance to microorganism growth, including bacterial, fungal and algae growth, in a wide variety of working compositions, in particular water-based products. As the biocidal compositions are typically prepared containing relatively high concentrations of active ingredients (i.e., biocides), they generally find use as concentrates which are combined, in relatively small quantities, with one or more other ingredients in order to formulate a final product suitable for use for its intended purpose.

In one aspect, the working compositions of the disclosure comprise water, one or more organic compounds, and a biocidal composition comprising a combination IPBC and zinc oxide effective for wet-state anti-bacterial preservation of the working composition. The IPBC and zinc oxide may be present in the working composition in a weight ratio of 25:1 to 1:25.

In various aspects, the working composition is a paint or coating composition, wherein other ingredients may include one or more pigments, polymeric resin binders or fillers (e.g., latex resins), and a carrier vehicle such as water. Particular polymeric resins include acrylate, butadiene, PVA, EVA, styrene, or vinyl acetate polymers. In one embodiment of the disclosure, the biocidal composition is dosed into a coating composition, in particular a water-based coating composition such as a latex paint, in an amount of 0.2 to 3% by weight of the coating composition.

In another aspect, the working composition of the disclosure may be a joint sealing compound. Joint sealing compound (also known as wallboard joint compound, drywall joint compound, or wallboard mud) is used to attach tape to wallboard (also known as drywall, plasterboard or sheetrock) in order to cover the tape and conceal imperfections in the surface of the wallboard. A typical wallboard joint compound contains substantial or larger proportions of gypsum or limestone and water and relatively smaller proportions of stone, clay, and a polymer.

The biocidal compositions of the present disclosure may, for instance, be employed any of the following types of products: cosmetic, toiletry, personal care, household, laundry, cleaning, disinfecting, paint, coating, mineral slurry, pigment, pulp slurry, paper slurry, paper, metal working fluid, construction, plant nutrient, polymer lattice, wallboard joint compound, wallboard, spackling, sealant, stucco, mastic, asphalt emulsion, wood preservative, lazure, stain, plaster, adhesive, textile, leather treatment, hide treatment, non-woven fabric, building material, stucco, concrete, or caulk products, and any other application in which the inhibition or prevention of the growth of undesired microorganisms is desired in both the wet-state and the dry-film state.

### Methods of Use

Another aspect of the disclosure comprises a method of enhancing antibacterial activity of IPBC in a wet-state working composition comprising water and one or more organic compounds, comprising treating the working composition with IPBC in the presence of zinc oxide. The IPBC and zinc oxide may be present in a weight ratio of 25:1 to 1:25, 20:1 to 1:20, 15:1 to 1:15, 10:1 to 1:10, 5:1 to 1:5, or 4:1 to 1:4. In another aspect, the weight ratio of IPBC to ZnO is 2:1. The zinc oxide may comprise zinc oxide nanoparticles. In a further aspect of the method, the working composition is further treated with one or more bacterial membrane disrupting substances. The one or more bacterial membrane disrupting substances may comprise 1,2-hexanediol, hexyl carbitol, TPnB glycol ether, butoxytrigycol, or triacetin.

In a further aspect of the method, the working composition is further treated with one or more additional biocidal substances, which may comprise one or more antifungal substances and/or one or more algaecidal substances.

In a further aspect, a method of use comprises treating the working composition with a wet-state antibacterially effective amount of a biocidal composition comprising 1% to 25% by weight IPBC, 1% to 25% by weight zinc oxide, and 40% to 80% by weight 1,2-hexanediol, based on the weight of the biocidal composition. The biocidal composition used in the method further may comprise 10% by weight IPBC, 5% by weight zinc oxide, and 60% by weight 1,2-hexanediol, based on the weight of the biocidal composition.

In a further aspect, a method of use comprises treating the working composition with a wet-state antibacterially effective amount of a biocidal composition comprising 1% to 25% by weight IPBC, 1% to 25% by weight zinc oxide, and 40% to 80% by weight hexyl carbitol, based on the weight of the biocidal composition. The biocidal composition used in the method further may comprise 10% by weight IPBC, 5% by weight zinc oxide, and 60% by weight hexyl carbitol, based on the weight of the biocidal composition.

Another aspect of the disclosure comprises a method of treating an aqueous working formulation containing one or more organic compounds, to prevent, inhibit, or reduce wet-state bacterial contamination of the formulation, comprising treating the working formulation with a biocidal composition comprising an antibacterially effective combination of IPBC and zinc oxide as described herein above.

Within this specification, embodiments have been described in a way which enables a clear and concise specification to be written, but it is intended and will be appreciated that embodiments may be variously combined or separated without departing from the disclosure. For example, it will be appreciated that all preferred features described herein are applicable to all aspects of the disclosure described herein.

In some embodiments, the disclosure herein can be construed as excluding any element or process step that does not materially affect the basic and novel characteristics of the composition or process. Additionally, in some embodiments, the disclosure can be construed as excluding any element or process step not specified herein.

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material. It will be understood that, in certain example embodiments, the compositions described herein may be substantially free of any substance not specifically recited.

As used in this application and in the claims, the singular forms “a,” “an,” and “the” include the plural forms unless the context clearly dictates otherwise. Additionally, the term “includes” means “comprises.” The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

Unless otherwise indicated, all numbers expressing quantities of ingredients, properties such as molecular weight, percentages, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” means by weight as a percentage of the total weight or relative to another component in the composition.

The phrase “effective amount” means an amount of a compound that promotes, improves, stimulates, or encourages a response to the particular condition or disorder or the particular symptom of the condition or disorder.

Although the disclosure is illustrated and described herein with reference to specific embodiments, the disclosure is not intended to be limited to the details shown. Rather, various modifications may be made in the details within the scope and range of equivalents of the claims and without departing from the disclosure.

### EXAMPLES

### Experimental Methods:

### Growth Curves

To generate growth curves, overnight cultures of Pseudomonas aeruginosa (ATCC #10145) from Plate Count Agar were lifted and resuspended in dH₂O and adjusted to OD₆₀₀=0.01 with sterile Mueller Hinton Broth (MHB). This culture was distributed into wells of an uncovered 96-well plate with the indicated biocides. The OD₆₀₀ was then measured initially and then every 30′ for 16 hours at 37° C. with constant double orbital shaking. Due to the opacity of the samples dosed with some test compounds, the curves were generated by background subtracting from wells containing sterile MHB and then subtracted from their initial (t=0) measurement.

### Minimum Inhibitory Concentration Testing

MICs were determined via microbroth dilution using the following specific test parameters:

| Format | 96-well plate | |
|---|---|---|
| Strength | ~1.0*10⁵ | CFU/mL |
| Standardization | OD₆₀₀ | |
| Incubation Temperature | 35° | C. |
| Incubation Time | 2 | days |

| | |
|---|---|
| Test Endpoint | No growth (via turbidity) |
| Test Media | MHB |

Necessary organism dilutions via OD600 were calculated based on OD600 of 1.0 being equivalent to 8×108 CFU/mL. Biocide dilutions were performed in 2-fold increments for each assay.

### Synergy Index Calculations

Synergy index (SI) scores were calculated according to the mass action equation below:

S.I.[MIC[A]in-blend/MIC[A]alone]+[MIC[B]in-blend/MIC[B]alone]

Combinations of ingredients were determined to be synergistic (S.I.<0.5), additive (S.I.>0.5 to 1), indifferent (S.I.>1 to <2) or antagonistic (S.I.>2), as defined by EUCAST guidelines. See European Committee for Antimicrobial Susceptibility Testing (EUCAST) of the European Society of Clinical Microbiology and Infectious Diseases (ESCMID). EUCAST Definitive Document E.Def 1.2, May 2000: Terminology relating to methods for the determination of susceptibility of bacteria to antimicrobial agents, Clin. Microbiol. Infect. Off Publ. Eur. Soc. Clin. Microbiol. Infect. Dis. 6, 503-508 (2000); Helander I. M., Mattila-Sandholm T., Fluorometric assessment of gram-negative bacterial permeabilization, J. Appl. Microbiol. 88:213-219 (2000).

### Checkerboard Assay

The checkerboard assay was performed by separately dosing Polyphase PW40 (40% IPBC) and a 20% nanoparticle ZnO dispersion (Sigma #721077) into 100 microliters of Mueller Hinton Broth containing ˜1.0*10⁵ CFU/mL of Pseudomonas aeruginosa (ATCC #10145). The plate was then incubated overnight at 37° C. with constant double orbital shaking. The next day, the dispersions were allowed to settle on the bench for 2 hours and the plate was photographed. Growth in this assay was defined as the turbidity of the supernatant.

### Kill Curve

Overnight cultures of Pseudomonas aeruginosa (ATCC #10145) growing in Tryptic Soy Broth were diluted to OD₆₀₀=0.7 in Mueller Hinton Broth containing the indicated level of test compound. Samples containing IPBC were dosed with Polyphase PW40 (40% IPBC). Samples containing ZnO were dosed from a 50% ZnO dispersion (“1678-54”). Time points were collected by adding 1 mL of the sample into 9 mL of Dey-Engley Neutralizing Broth and performing a serial dilution in 1× Butterfield's Phosphate Buffer. Counts were obtained from pour plates in Tryptic Soy Agar after overnight incubation at 35° C.

### NPN Uptake Assay

The NPN uptake assay was performed roughly as previously described. See Helander I. M., Mattila-Sandholm T., Fluorometric assessment of gram-negative bacterial permeabilization, J. Appl. Microbiol. 88:213-219 (2000), doi: 10.1046/j.1365-2672.2000.00971.x. A culture of Pseudomonas aeruginosa (ATCC #10145) was grown overnight in Tryptic Soy Broth (TSB), then diluted with sterile TSB to OD₆₀₀=0.1 and grown into early exponential phase. Next, the cells were centrifuged (10,000 g, 5 minutes) washed twice with assay buffer (5 mM HEPES-KOH, 5 mM glucose, pH 7.2) and resuspended in assay buffer to OD₆₀₀=1. 100 microliters of washed cells in assay buffer was then mixed with 100 microliters of assay buffer containing 20 μM NPN in a 96-well optical bottom black plate (Thermo). Two microliters of the test substances were then added, briefly mixed, and then placed in a plate reader to monitor fluorescence (excitation 350 nm, emission 420 nm) at one minute intervals for 10 minutes. Controls containing no cells or water-only were included in the assay. NPN uptake was calculated using the formula below at each time point and averaged over all time-points and three replicates.

$$NPN Uptake = ( {F}_{sample} - {F}_{no cells} ) - ( {F}_{cells} - {F}_{no cells} )$$

### Bacterial and Fungal Challenge Testing (Standard)

Bacterial and fungal challenge testing was performed following Troy's standard challenge test procedure SOP MI-07. The bacterial organisms were Alcaligenes faecalis (ATCC #25094), Enterobacter aerogenes (ATCC #13048), Escherichia coli (ATCC #11229), Pseudomonas aeruginosa (ATCC #10145). All bacteria were blended from overnight cultures on Plate Count Agar (PCA) and mixed at equal CFU via OD₆₀₀ measurements, then diluted to OD₆₀₀=0.7 (˜108 CFU/mL) to create the final bacterial consortium. Where indicated, additional bacterial organisms were added to the inoculum such that each organism in the inoculum provided equal CFU. The fungal organisms used in the wet-state fungal challenge were Aspergillus niger (ATCC #6275) and Penicillium funiculosum (ATCC #12667). Fungal consortia were prepared on Malt Agar slants and diluted to 10⁶ spores/mL using a hemocytometer to count before use. Each mixture was prepared shortly before each inoculation. Inoculations were performed by adding 0.5 mL to 50 g of the indicated test sample, giving either ˜10⁶ CFU/g of bacteria or ˜10⁴ spores/g of fungi per challenge. Viability readings were performed at the indicated intervals following each challenge by applying a small amount of the test sample onto PCA (for bacteria) or Malt Agar (for fungus). Bacterial plates were then incubated at 32° C. for 3-5 days, and Malt Agar plates were incubated for 1 week at 28° C. before reading. Viability plates were evaluated with a semi-quantitative scale. This scale estimates the approximate CFU/g by visual assessment of the colony density along the streak lines. Readings are recorded as the average of two duplicate semi-quantitative readings from “0” to “4.” Samples were mixed before every viability reading and after every inoculation.

| Colony Count | Rating | Approximate CFU/g¹ |
|---|---|---|
| 0 | 0 | <1 |
| 1-10 | 1 | 10-10² |
| 11-100 | 2 | 10³-10⁴ |
| 101-1000 | 3 | 10⁴-10⁵ |
| >1000 | 4 | >10 |

¹Lunenburg-Duindam, Jenny & Lindner, Wolfgang, In-can preservation of emulsion paints, European Coatings Journal, 66-73 (2000).

### Bacterial Challenge Testing (Industrial Strength)

Where industrial strength inoculations are indicated, bacterial challenge testing organisms were Alcaligenes faecalis (ATCC #25094), Enterobacter aerogenes (ATCC #13048), Escherichia coli (ATCC #11229), Pseudomonas aeruginosa (ATCC #10145), Staphylococcus aureus (ATCC #6538), Microbacterium paraoxydans (Troy Isolate), Burkholderia cenocepacia (Troy Isolate), Citrobacter werkmanii (Troy Isolate), and Acinetobacter sp. (Troy Isolate). All bacteria were blended from separate overnight cultures grown in Tryptic Soy Broth (TSB) and mixed at equal CFU via OD₆₀₀ measurements, then diluted to OD₆₀₀=7 (˜10⁹ CFU/mL) to create the final bacterial consortium. Each mixture was prepared shortly before each inoculation. Inoculations were performed by adding 0.1 mL to 50 g of the indicated test sample to give ˜10⁷ CFU/g per inoculation. Viability readings were performed at the indicated intervals following each challenge by applying a small amount of the test sample onto PCA. Plates were then incubated at 32° C. for 3-5 days before being evaluated with a semi-quantitative scale. This scale estimates the approximate CFU/g by visual assessment of the colony density along the streak lines. Readings are recorded as the average of two duplicate semi-quantitative readings from “0” to “4.” Samples were mixed before every viability reading and after every inoculation.

| Colony Count | Rating | Approximate CFU/g¹ |
|---|---|---|
| 0 | 0 | <1 |
| 1-10 | 1 | 10-10² |
| 11-100 | 2 | 10³-10⁴ |
| 101-1000 | 3 | 10⁴-10⁵ |
| >1000 | 4 | >10 |

¹Lunenburg-Duindam, Jenny & Lindner, Wolfgang, In-can preservation of emulsion paints, European Coatings Journal, 66-73 (2000).

### Challenge Test Scoring

Challenge test scoring was done by the weighted sum of squares for each of the twelve data points collected for each test sample. The weighting was done proportional to the streak day, with day 1 weighted at 10%, day 2 weighted at 20%, and day 3 weighted at 70%. The sum of all 12 values is then taken and divided by the score of the unprotected sample to achieve the total growth score. The reported “weighted performance” score is 1 minus the growth score.

### Dry-Film Mildew Resistance Testing

Dry-film mildew resistance testing was performed generally following ASTM D5590 with testing occurring against organisms Aureobasidium pullulans (ATCC #9348) and a mixture of Aspergillus niger (ATCC #6275) and Penicillium funiculosum (ATCC #11797). Suspensions of these organisms were prepared from Malt Agar slants and adjusted to 1·10⁶ spores/mL with a hemocytometer. Test films were created by applying a thin layer of the paint to Whatman #2 filter paper and drying for 3-5 days. The prepared films were then cut to 1″×1″ and inoculated with 0.2 mL of the suspensions onto Malt Agar and incubated for 1 month at 28° C. The fungal growth coverage on the paint surface was then rated between “0” and “4” depending on the degree of coverage according to ASTM D5590. Zones of inhibition are reported separately as z(x) where x is the average size of the zone in millimeters.

### Dry-Film Bacterial Resistance Testing

Films from test paint “Interior Paint #4” were dosed with Polyphase PW40 or Omniphase Z at IPBC levels of 300, 500, 700, and 900 ppm, mixed, and cast into 5 mil films on black Leneta. After drying, the films were evaluated for bacterial resistance according to JIS Z2801 with 24 hours of contact against organisms E. coli (ATCC #8739) and S. aureus (ATCC #6538). Log reductions were calculated using the unprotected paint as a basis.

Test Biocide Compositions

| Chemical Name | Percentage | CAS# |
|---|---|---|
| Ref - “1721-18-2” [“A”] | | |
| 1,2-hexanediol | 60% | 6920-22-5 |
| Iodopropynyl Butyl Carbamate (IPBC) | 15% | 55406-53-6 |
| Polyethylene Glycol 200 | 25% | 25322-68-3 |
| Ref - “1721-18-4” [“B”] | | |
| 1,2-hexanediol | 60% | 6920-22-5 |
| Iodopropynyl Butyl Carbamate (IPBC) | 15% | 55406-53-6 |
| Polyethylene Glycol 200 Monolaurate | 15% | 9004-81-3 |
| Zinc Oxide | 5% | 1314-13-2 |
| Water | 5% | 7732-18 |
| Ref - “1721-18-5” [“C”] | | |
| Polyphase AF3 (30% IPBC) | 50% | N/A |
| Polyethylene Glycol 200 | 50% | 25322-68-3 |
| Ref - “1721-52”/“1721-66”/“Omniphase Z” | | |
| 1, 2-hexanediol | 60% | 6920-22-5 |
| Iodopropynyl Butyl Carbamate (IPBC) | 10% | 55406-53-6 |
| Polyethylene Glycol 200 | 5% | 25322-68-3 |
| Zinc Oxide | 5% | 1314-13-2 |
| Silica Oxide | 2% | 68611-44-9 |
| Kaolin Clay | 18% | 1332-58-7 |
| Ref - “1678-54” [50% ZnO] | | |
| Water | 47.7% | 7732-18 |
| Zinc Oxide | 50.0% | 1314-13-2 |
| Dispersant (Biosoft N411) | 2.0% | N/A |
| Defoamer (XFO-713) | 0.05% | N/A |
| Xantham Gum | 0.3% | N/A |
| Ref - “1721-80” [40% ZnO] | | |
| Water | 57.7% | 7732-18 |
| Zinc Oxide | 40.0% | 1314-13-2 |
| Dispersant (Biosoft N411) | 2.0% | N/A |
| Xantham Gum | 0.3% | N/A |
| Ref - “1721-81” [20% ZnO, 20% IPBC] | | |
| “1721-80” | 50.0% | N/A |
| Polyphase PW40 | 50.0% | N/A |
| Ref - “1729-79” [1,2-Hexanediol | | |
| Omniphase Z] | | |
| 1,2-Hexanediol | 60.0% | 7732-18 |
| Iodopropynyl Butyl Carbamate (IPBC) | 10.3% | 1314-13-2 |
| Zinc Oxide | 5.0% | N/A |
| Aerosil R972 | 3.5% | N/A |
| Kaolin | 8.2% | N/A |
| BNX 1010 | 0.5% | 6683-19-8 |
| Araldite GY 250 | 5.0% | 85101-00-4 |
| PEG 200 DL | 7.5% | 9005-02-1 |
| Ref - “1729-79” [DMDA Omniphase Z] | | |
| N,N-dimethyldecylamine | 50.0% | 1120-24-7 |
| Iodopropynyl Butyl Carbamate (IPBC) | 15.5% | 55406-53-6 |
| Zinc Oxide | 5.0% | 1314-13-2 |
| Aerosil R972 | 4.0% | 68611-44-9 |
| Kaolin | 12.0% | 1332-58-7 |
| Ninol CMP | 5.0% | 68140-00-1 |
| Epoxidized linseed oil | 5.0% | 8016-11-3 |
| Soprophor BSU | 3.5% | 70559-25-0 |
| Ref - “1750-8” [Hexyl Carbitol Omniphase Z] | | |
| Hexyl Carbitol Solvent | 50.0% | 112-59-4 |
| Texanol | 10.0% | 25265-77-4 |
| Iodopropynyl Butyl Carbamate (IPBC) | 10.2% | 55406-53-6 |
| Zinc Oxide | 5.0% | 1314-13-2 |
| Aerosil R972 | 4.5% | 68611-44-9 |
| Kaolin | 15.2% | 1332-58-7 |
| BNX 1010 | 0.1% | 6683-19-8 |
| Epoxidized linseed oil | 5.0% | 8016-11-3 |

Commercial Product Compositions

| Product | Active Content | Carrier |
|---|---|---|
| Polyphase PW40 | 40% IPBC | Water-based dispersion |
| Polyphase P20T | 20% IPBC | Glycolic solution |

### Unpreserved Matrices

Unpreserved test matrices of paint and colorant were obtained from the following Troy projects:

| Troy Code | Sample Type |
|---|---|
| U19-0785-2 | Interior Paint #1 |
| U19-0785-3 | Interior Paint #2 |
| U19-0785-4 | Interior Paint #3 |
| U20-0710-1 | Interior Paint #4 |
| U20-0586-1 | Colorant (Black) |
| U20-0586-2 | Colorant (Red) |
| U21-0108-03 | Interior Paint #5 |

Joint compound was produced internally according to the recipe below:

| Formulation | # | Type | Addition | % |
|---|---|---|---|---|
| Joint | 1 | Water | 1800 g Tap Water | 45 |
| Compound #1 | 2 | Defoamer | 8 g Troykyd D121 | 0.2 |
| | 3 | Limestone | 1760 g Camel White | 44 |
| | 4 | Mica | 160 g Mica 325 | 4 |
| | 5 | Polymer | 132 g Vinnapas 4010L | 3.3 |
| | 6 | Thickener | 20 g Natrosol 250HBR | 0.5 |
| | 7 | Clay | 120 g Attagel 40 | 3 |

### Example 1

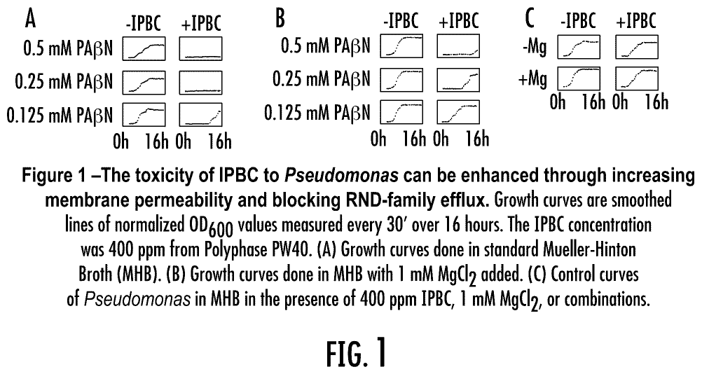

Using the IPBC-resistant organism Pseudomonas, the growth of Pseudomonas aeruginosa (ATCC #10145) was measured over 16 hours at 37° C. in the presence of 0.125-0.5 mM PAβN (Sigma #P4157) with and without IPBC (0.1% w/w Polyphase PW40; 400 ppm IPBC). Testing showed that PAβN had minimal impact on Pseudomonas growth alone, but ≥0.25 mM PAβN with 400 ppm IPBC caused complete growth inhibition of Pseudomonas over 16 hours (FIG. 1A).

As PAβN also causes membrane destabilization at higher concentrations, the role of efflux was isolated by stabilizing the membrane through addition of MgCl₂. See Lamers, R. P. et al., The efflux inhibitor phenylalanine-arginine beta-napthylamide (PAbetaN) permeabilizes the outer membrane of gram-negative bacteria, PLoS ONE 8:e60666 (2013). Growth curves collected in the presence of 1 mM MgCl₂ showed weaker IPBC potentiation, and Pseudomonas was capable of growth but lagged before exponential in a PAβN concentration-dependent manner (FIG. 1B). Control results showed no Pseudomonas inhibition in the presence of IPBC, MgCl₂, or combinations (FIG. 1C). Combined, the results suggest that poor membrane permeability of IPBC and active efflux are important factors to Pseudomonas resistance to IPBC.

### Example 2

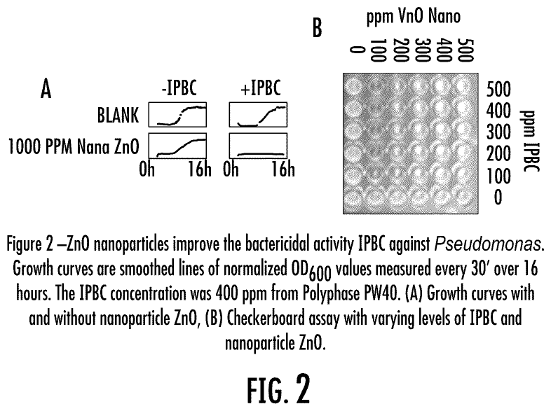

To determine if nanoparticle ZnO could potentiate IPBC, Pseudomonas aeruginosa (ATCC #10145) growth curves were repeated as in FIG. 1. The source of IPBC was again Polyphase PW40 and a 20% nanoparticle ZnO suspension from Sigma-Aldrich (St. Louis, MO) was used to deliver the nanoparticle ZnO. Testing showed that the combination showed complete growth inhibition over 16 hours with the combination of IPBC and ZnO nanoparticles, but growth in the presence of 400 ppm IPBC or 1000 ppm nanoparticle ZnO alone (FIG. 2A). To investigate the effect further, a checkerboard assay was performed with combinations of between 100-500 ppm ZnO nanoparticles and 100-500 ppm IPBC. After 24 hours of incubation with constant agitation to keep the dispersions suspended, wells containing only IPBC or ZnO nanoparticles were turbid, while all wells containing combinations of IPBC and nanoparticle ZnO were free of turbidity (FIG. 2B).

### Example 3

The activity of IPBC and standard ZnO against diverse bacterial organisms was investigated with minimum inhibitory concentration (MIC) testing. However, as nanoparticle ZnO is more costly than standard and carries additional regulatory scrutiny through EPA, the ability of standard grade ZnO to enhance IPBC's activity against diverse bacterial species was evaluated. MIC testing showed that IPBC and ZnO were synergistic against most bacteria (SI<0.5), but showed additive effects against bacteria that were already highly susceptible to IPBC (Table 1).

### Example 4

The usefulness of IPBC/ZnO combinations for paint preservation was tested. Additions of 40% IPBC, 40% ZnO, or a blend containing 20% IPBC with 20% ZnO were added to paint between 0.5 and 2.5% w/w (2,000-10,000 ppm a.i.) and tested for bacterial resistance using an industrial inoculum. The challenge test overall showed weak preservation of all three blends, though ZnO and ZnO/IPBC showed improved activity over IPBC (Table A1) and achieved complete kill of the inoculum 7 days after challenge at 2.5% w/w (10,000 ppm).

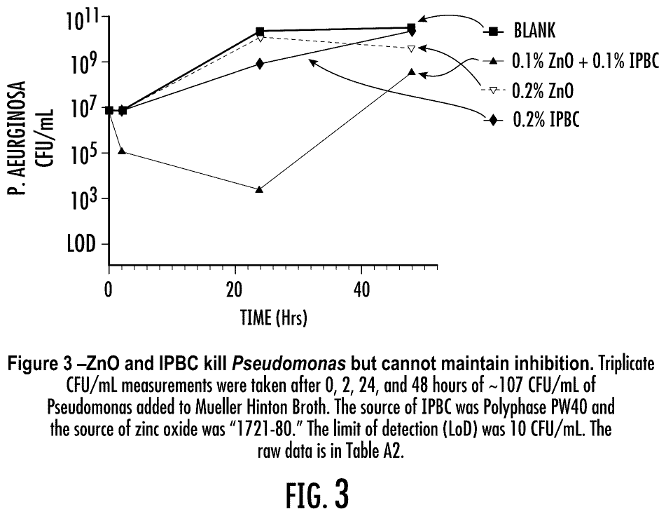

To determine the kill effect of IPBC/ZnO, Pseudomonas aeruginosa (ATCC #10145) again was used, as it appeared to be the most resistant to IPBC (Table 1). Kill curves done with Pseudomonas and 2000 ppm IPBC, 2000 ppm ZnO, and 1000 ppm of each showed that the combination was able to cause a 2 log₁₀ (99%) reduction of Pseudomonas viability after 2 hours of contact and 5 log₁₀ reduction of Pseudomonas viability after 24 hours of contact (>99.99%). However, the 48-hour measurement showed the Pseudomonas growth return, indicating either that the preservative was depleted by its own action or that the surviving Pseudomonas made metabolic changes to overcome growth inhibition (FIG. 3).

TABLE 1
IPBC/ZnO is synergistic against many diverse bacterial organisms.

| | | IPBC | ZnO | IPBC:ZnO | |
|---|---|---|---|---|---|
| | Strain | (Polyphase | (“1721- | (“1721- | Synergy |
| Test Organism | Identifier | PW40) | 80”) | 81”) | Index |
| P. aeruginosa | ATCC #10145 | ≥400 | ≥2400 | 1600 | ≤0.33 |
| S. aureus | ATCC #6538 | 450 | 250 | 250 | 0.78 |
| E. coli | ATCC #11229 | 2400 | 2400 | 500 | 0.21 |
| E. aerogenes | ATCC #13048 | 1000 | 2400 | 350 | 0.25 |
| Burkholderia sp. | Troy JZ2 | 63 | 2000 | 125 | 1.02 |
| Microbacterium sp. | Troy JZ13 | 11 | 3206 | 11 | 0.50 |
| Pseudomonas sp. | Troy JZ103 | 300 | 3400 | 250 | 0.45 |
| Bacillus sp. | Troy JZ14 | 9 | 3212 | 16 | 0.89 |

MIC values were collected from 96 well microbroth dilution assays with the indicated test organism in MHB after 24 hours of incubation. All values are reported in ppm.

### Example 5

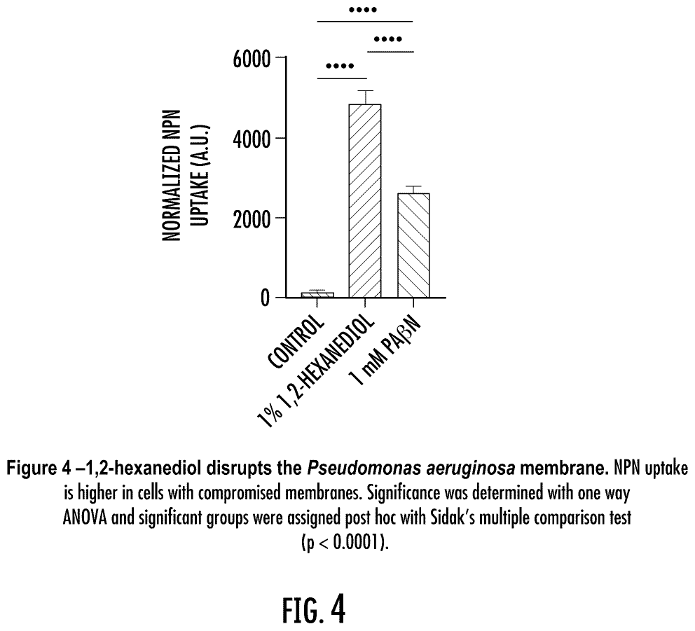

The boosting effect of 1,2-hexanediol to enhance overall efficacy in industrial systems was evaluated. PAβN's ability to potentiate IPBC activity was at least partially due to increases in membrane permeability (FIG. 1). The ability of 1,2-hexanediol to increase the membrane permeability of Pseudomonas aeruginosa (ATCC #10145) was investigated. To quantify this effect, the fluorescent probe 1-N-phenylnapthylamine (NPN) was used as an indicator for membrane permeability. NPN is only weakly fluorescent in solution and normally cannot enter cells efficiently, but fluoresces strongly when bound to phospholipids in the cell. The NPN assay results showed that 1% 1,2-hexanediol significantly increased the permeability of the Pseudomonas membrane (FIG. 4).

### Example 6

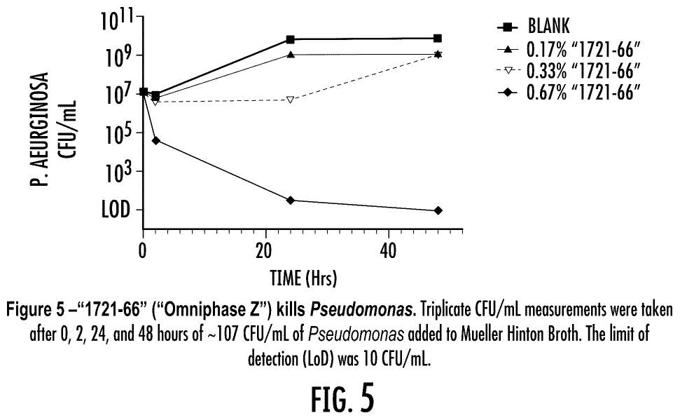

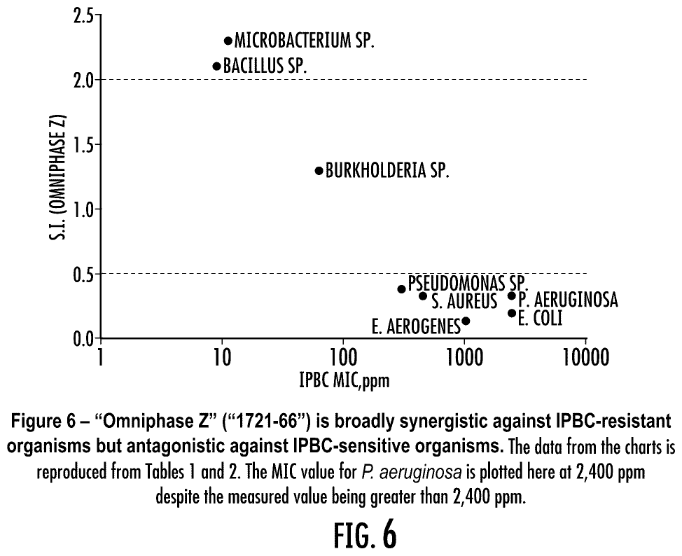

To measure the activity improvement of blends containing 1,2-hexanediol with IPBC/ZnO, a formulation containing 10% IPBC, 500 ZnO, and 60% 1,2-hexanediol (“Omniphase Z”) was formulated and tested for MIC values against the same organisms as in Table 1. The MIC values of 1,2-hexanediol were also determined to calculate synergy index values. MIC tests showed that “Omniphase Z” was synergistic against most of the test bacteria, but additive or antagonistic against organisms most sensitive to IPBC—Burkholderia, Bacillus, and Microbacterium. Consistently, there was a clear positive relationship between the susceptibility of the test organism to IPBC and the synergy index of the “Omniphase Z” formulation (FIG. 6). Further, in contrast to the kill curve results obtained with IPBC/ZnO (FIG. 3), addition of 1,2-hexanediol was fully capable of killing Pseudomonas (FIG. 5).

### Example 7

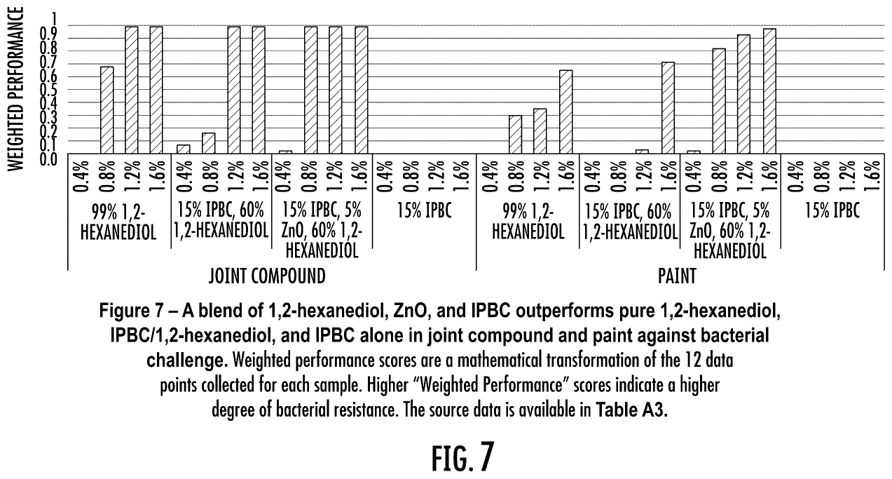

To differentiate the relative in-matrix bactericidal activity of 1,2-hexanediol from various combinations lacking one or more boosters, test formulations of 15% IPBC alone or in combination with 1,2-hexanediol or ZnO were prepared, tested, and compared to the performance of pure 1,2-hexanediol. Challenge testing was performed with a standard inoculum for the more susceptible joint compound (10⁶ CFU/g/challenge) and with an industrial mixture for the paint (10⁷ CFU/g/challenge) over four inoculations, with the test mixtures added between 0.4-1.6% w/w (4000-16,000 ppm). The challenge results show that the blend of 1,2-hexanediol, IPBC, and ZnO outperforms all other blends in joint compound and paint (FIG. 7, Table 3). The data strongly suggests that IPBC significantly contributes to wet-state bactericidal activity when in combination with 1,2-hexanediol and ZnO, and the combination of all three provides useful industrial preservation.

TABLE 2
“1721-66” (“Omniphase Z”)” is broadly active and
synergistic against many diverse bacterial organisms.

| | | 1,2- | Omniphase Z | |
|---|---|---|---|---|
| | Strain | hexanediol | (“1721- | Synergy |
| Test Organism | Identifier | (Sigma) | 66”) | Index |
| P. aeruginosa | ATCC #10145 | 6000 | 2500 | ≤0.33 |
| S. aureus | ATCC #6538 | 24000 | 750 | 0.34 |
| E. coli | ATCC #11229 | 6000 | 1250 | 0.14 |
| E. aerogenes | ATCC #13048 | 10000 | 750 | 0.20 |
| Burkholderia sp. | Troy JZ2 | 5000 | 750 | 1.30 |
| Microbacterium | Troy JZ13 | 6000 | 250 | 2.30 |
| sp. | | | | |
| Pseudomonas sp. | Troy JZ103 | 5000 | 813 | 0.38 |
| Bacillus sp. | Troy JZ14 | 10000 | 188 | 2.10 |

MIC values were collected from 96 well microbroth dilution assays with the indicated test organism in MHB after 24 hours of incubation. All values are reported in ppm.

TABLE 3
Pass level of IPBC, ZnO, and 1,2-hexanediol combinations
in bacterial challenge testing in two formulations.

| Matrix | Test Substance | Pass Level (ppm a.i.) |
|---|---|---|
| Joint Compound | 99% 1,2-hexanediol | 1.2% w/w (11,880) |
| | 15% IPBC, 60% 1,2-hexanediol; | 1.2% w/w (9,000) |
| | “1721-18-2” [“A”] | |
| | 15% IPBC, 60% 1,2-hexanediol, 5% | 0.8% w/w (6,400) |
| | ZnO; “1721-18-4” [“B”] | |
| | 15% IPBC; “1721-18-5” [“C”] | Not Effective. (>12,000) |
| Interior Paint #1 | 99% 1,2-hexanediol | Not Effective (>12,000) |
| | 15% IPBC, 60% 1,2-hexanediol; | Not Effective (>12,000) |
| | “1721-18-2” [“A”] | |
| | 15% IPBC, 60% 1,2-hexanediol, 5% | 0.8% w/w (6,400) |
| | ZnO; “1721-18-4” [“B”] | |
| | 15% IPBC; “1721-18-5” [“C”] | Not Effective (>12,000) |

15% IPBC, 60% 1,2-hexanediol, and 5% ZnO pass four bacterial successive inoculations of bacteria at 0.8% w/w (6,400 ppm a.i.) in joint compound and paint, while blends containing 15% IPBC and 60% 1,2-hexanediol or 99% 1,2-hexanediol alone require higher levels or fail to show significant performance in challenge testing. The pass level is defined as the lowest test substance concentration that is free of detectable bacterial growth 7 days following the 4^{th} inoculation. The challenge raw data is available in Table A3.

### Example 8

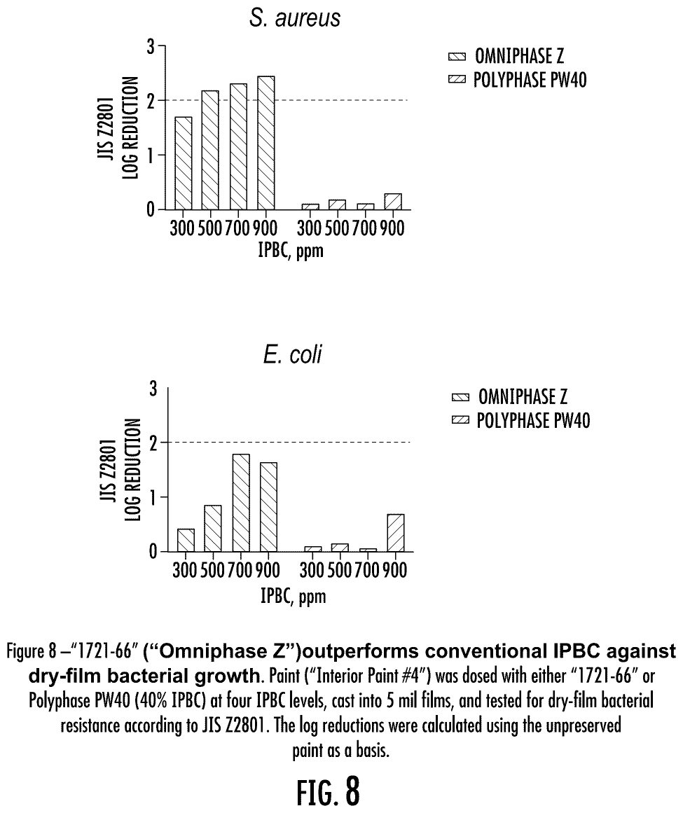

The activity of the formulated “Omniphase Z” (“1721-66” or “1721-52”) in additional matrices and further functionalities for wet-state and dry-film microbial control was characterized. Challenge testing in paint through four inoculations showed that “Omniphase Z” confers wet-state bacterial and fungal control and dry-film fungal control at 0.75 w/w (Tables A4, A5, A6). In the colorants, testing showed that “Omniphase Z” protected them from wet-state bacterial and fungal growth at 0.8%0 w/w though four inoculations (Table A7, A8). Additionally, “Omniphase Z” significantly outperformed conventional IPBC against dry-film bacterial growth when tested according to JIS Z2801 (FIG. 8).

### Example 9

Four additional solvents with chemical properties similar to 1,2-hexanediol were tested for their ability to improve the antibacterial of IPBC/ZnO in paint activity against Pseudomonas. Paint challenge testing of these solvents showed that the three glycol ether solvents and triacetin showed some improvement in the bacterial resistance of paint containing IPBC/ZnO (Table A9). Hexyl Carbitol provided highly similar performance as 1,2-hexanediol at boosting the antibacterial activity of IPBC/ZnO in paint.

### Example 10

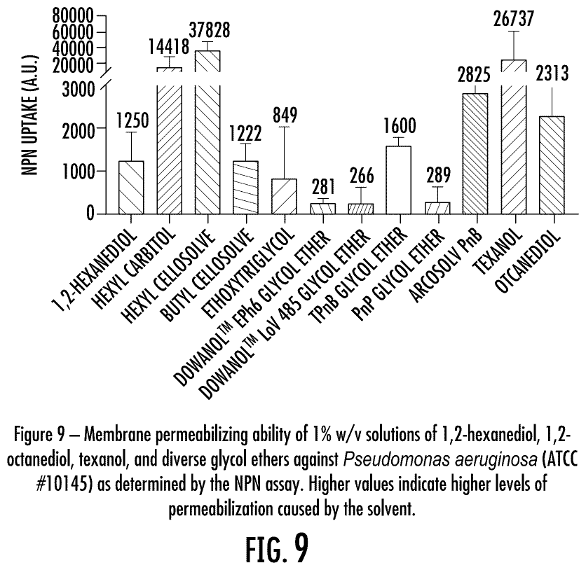

Boosting of IPBC/ZnO activity in paint was previously theorized to be linked to membrane permeabilization (Example 5). Various glycol ethers were tested for their relative ability to permeabilize the Pseudomonas membrane using the NPN assay. Results showed a wide variation in the membrane permeabilization activity of 1% w/v solutions of the glycol ethers, though Hexyl Carbitol, Hexyl Cellosolve, and the ester alcohol, Texanol, possessed the highest membrane disruption potential against Pseudomonas (FIG. 9).

### Example 11

The relative activity of the vicinal diols, glycol ethers, and the alcohol ester Texanol to confer antibacterial activity of IPBC/ZnO was determined in paint at 0.5% w/w. To separate potential protective effects of the materials themselves, activity was measured in paint with and without IPBC/ZnO. Bacterial challenge testing through four inoculations showed that all materials except 1,2-octanediol were incapable of protecting paint from bacterial growth on their own, but several conferred strong antibacterial protection to paint when combined with IPBC/ZnO, which itself was ineffective (Table A10). The results demonstrate that neither IPBC/ZnO nor various glycol alone are sufficient to preserve paint, but combinations show highly effective preservation activity (Table A10).

### Example 12

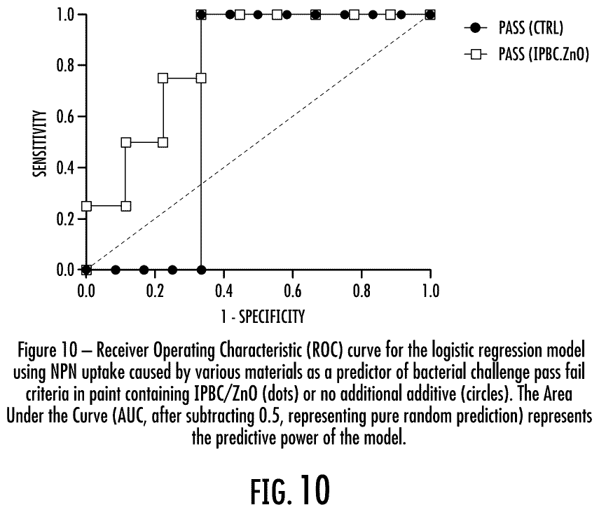

To determine whether the degree of membrane permeabilization by each substance was predictive of their ability to enhance the antibacterial activity of IPBC/ZnO in paint, a logistical regression was performed to determine if NPN uptake (FIG. 9) was predictive of pass-fail criteria from the bacterial challenge test (Table A10). Pass (“1”) was defined as a “0” rating 7 days following the fourth bacterial challenge; fail (“0”) was defined as any other number. Data from the logistical regression strongly shows that NPN uptake is more predictive of passing results in the challenge test provided IPBC/ZnO is also in the paint (AUC-0.5=0.33), and significantly less predictive when IPBC/ZnO was absent (AUC-0.5=0.17). The ROC curve is shown in FIG. 10. These results collected for these materials clearly demonstrate that membrane permeabilization is an important feature of enhancing the antibacterial activity of IPBC/ZnO in paint.

### Example 13

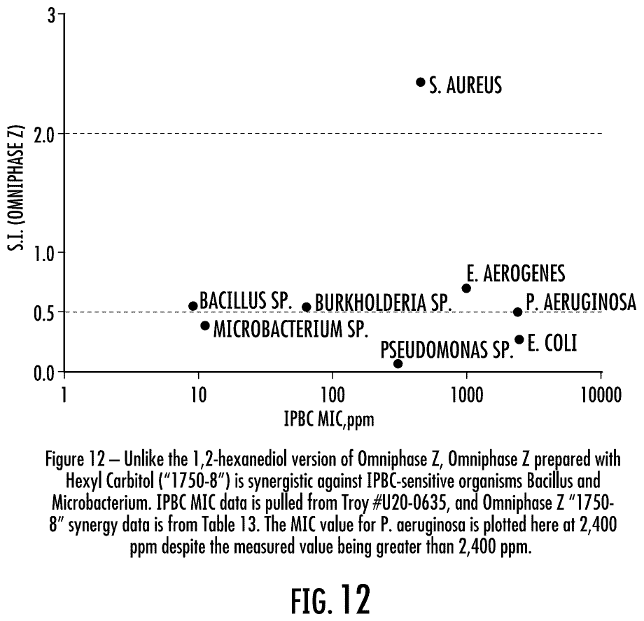

Of the effective 1,2-hexanediol alternates tested, Hexyl Carbitol was selected for formulation. Solvent dispersion formulation “1750-8” was created with 10% IPBC, 5% ZnO, 50% Hexyl Carbitol, 10% texanol, and additional filler, stabilizing, and thickening agents. Characterization of formulation “1750-8” began by confirming synergy between IPBC/ZnO and Hexyl Carbitol in MIC tests. MIC tests of IPBC/ZnO, Hexyl Carbitol, and “1750-8” on diverse IPBC-sensitive and IPBC-resistant bacterial species showed strong synergy between the components (Table 4, FIG. 12).

TABLE 4
“1750-8” (“Omniphase Z” formulated with Hexyl Carbitol)
is broadly active and synergistic against diverse organisms.

| | | MIC, ppm | | | |
|---|---|---|---|---|---|
| | | | | Omniphase | |
| | Strain | IPBC/ZnO | Hexyl | Z—HC | Synergy |
| Test Organism | Identifier | (2:1) | Carbitol | (“1750-8”) | Index |
| P. aeruginosa | ATCC #10145 | 4447 | 11856 | 5929 | 0.50 |
| S. aureus | ATCC #6538 | 23 | 11857 | 370 | 2.43 |
| E. coli | ATCC #11229 | 231 | 11857 | 371 | 0.26 |
| E. aerogenes | ATCC #13048 | 1482 | 4447 | 2964 | 0.70 |
| Burkholderia sp. | Troy JZ2 | 370 | 1853 | 741 | 0.54 |
| Microbacterium sp. | Troy JZ13 | 93 | 1482 | 185 | 0.37 |
| Pseudomonas sp. | Troy JZ103 | 741 | 5929 | 185 | 0.06 |
| Bacillus sp. | Troy JZ14 | 2964 | 4447 | 2964 | 0.55 |

MIC values were collected from 96 well microbroth dilution assays with the indicated test organism in MHB after 24 hours of incubation. All values are reported in ppm.

### Example 14

The ability of formulation “1750-8” to kill the IPBC-resistant organism Pseudomonas in solution was evaluated. Testing showed that >=0.672 w/w of “1750-8” can cause a >6 log kill and can maintain inhibition through 48 hours (FIG. 6).

### Example 15

Bacterial challenge testing through four inoculations showed that 0.600 w/w showed good suppression of bacterial growth in the test paint, and higher levels showed better activity (Table 16).

### Tables Appendix:

TABLE A1
IPBC/ZnO combination challenge data in paint through
two challenges with an industrial inoculum.

| | | Week 1 | | | Week 2 | | |
|---|---|---|---|---|---|---|---|
| Composition | Test Sample | 1 d | 2 d | 7 d | 1 d | 2 d | 7 d |
| — | Interior Paint #3 | 4 | 4 | 4 | 4 | 4 | 4 |
| 40% IPBC | +0.5% Polyphase PW40 | 3 | 3 | 3 | 4 | 3 | 4 |
| | +1.0% Polyphase PW40 | 3 | 3 | 3 | 4 | 3 | 3 |
| | +1.5% Polyphase PW40 | 3 | 3 | 3 | 4 | 3 | 3 |
| | +2.0% Polyphase PW40 | 3 | 3 | 3 | 3 | 3 | 3 |
| | +2.5% Polyphase PW40 | 3 | 3 | 3 | 3 | 3 | 3 |
| 40% ZnO | +0.5% 1721-80 | 3 | 3 | 3 | 4 | 3 | 2 |
| | +1.0% 1721-80 | 3 | 3 | 2 | 3 | 3 | 2 |
| | +1.5% 1721-80 | 3 | 3 | 2 | 3 | 3 | 2 |
| | +2.0% 1721-80 | 3 | 3 | 2 | 3 | 3 | 1 |
| | +2.5% 1721-80 | 3 | 3 | 2 | 3 | 3 | 0 |
| 20% ZnO + | +0.5% 1721-81 | 3 | 3 | 3 | 3 | 3 | 2 |
| 20% IPBC | +1.0% 1721-81 | 3 | 3 | 3 | 3 | 3 | 2 |
| | +1.5% 1721-81 | 3 | 3 | 2 | 3 | 3 | 2 |
| | +2.0% 1721-81 | 3 | 3 | 2 | 3 | 3 | 2 |
| | +2.5% 1721-81 | 3 | 3 | 1 | 3 | 3 | 0 |

TABLE A2
Kill curve raw data for Pseudomonas aeruginosa (ATCC #10145) after
2, 24, and 48 hours of contact with 2000 ppm IPBC, 2000 ppm ZnO, and
1000 ppm ZnO + 1000 ppm IPBC. A graph of the data is presented in FIG. 3.

| | CFU/mL | | | | | |
|---|---|---|---|---|---|---|
| Time | Blank | | | 0.1% ZnO + 0.1% IPBC | | |
| (hrs) | Rep 1 | Rep 2 | Rep 3 | Rep 1 | Rep 2 | Rep 3 |
| 0 | 6.70E+06 | 8.70E+06 | 9.60E+06 | 7.70E+06 | 9.60E+06 | 8.00E+06 |
| 2 | 7.79E+06 | 7.50E+06 | 7.40E+06 | 1.11E+05 | 1.34E+05 | 1.24E+05 |
| 24 | 2.00E+10 | 2.74E+10 | 2.65E+10 | 2.00E+03 | 2.60E+03 | 3.50E+03 |
| 48 | 2.80E+10 | 4.40E+10 | 3.20E+10 | 5.71E+08 | 2.50E+08 | 4.86E+08 |
| Time | 0.2% ZnO | | | 0.2% IPBC | | |
| (hrs) | Rep 1 | Rep 2 | Rep 1 | Rep 2 | Rep 1 | Rep 2 |
| 0 | 5.40E+06 | 7.00E+06 | 5.40E+06 | 7.00E+06 | 5.40E+06 | 7.00E+06 |
| 2 | 7.10E+06 | 7.30E+06 | 7.10E+06 | 7.30E+06 | 7.10E+06 | 7.30E+06 |
| 24 | 1.33E+10 | 1.45E+10 | 1.33E+10 | 1.45E+10 | 1.33E+10 | 1.45E+10 |
| 48 | 4.90E+09 | 3.80E+09 | 4.90E+09 | 3.80E+09 | 4.90E+09 | 3.80E+09 |

TABLE A3
Bacterial challenge data for four test biocide formulations between 0.4-
1.6% w/w in Joint Compound and Interior Paint #1. Formulation “A”
contains 15% IPBC and 60% 1,2-hexanediol. Formulation “B” is the
same as “A” but with 5% ZnO, formulation “C” contains
only 15% IPBC, and formulation “D” is pure 1,2-hexanediol.

| | Days after Bacterial Challenge | | | | | | | | | | | |
|---|---|---|---|---|---|---|---|---|---|---|---|---|
| | Week 1 | | | Week 2 | | | Week 3 | | | Week 4 | | |
| Test Sample | 1 d | 2 d | 7 d | 1 d | 2 d | 7 d | 1 d | 2 d | 7 d | 1 d | 2 d | 7 d |
| Joint Compound | 4 | 4 | 4 | 4 | 4 | 4 | 4 | 4 | 4 | 4 | 4 | 4 |
| +0.4 w/w % “A” | 4 | 4 | 3 | 4 | 4 | 4 | 4 | 4 | 4 | 4 | 4 | 4 |
| +0.8 w/w % “A” | 3 | 3 | 2 | 4 | 4 | 4 | 4 | 4 | 4 | 4 | 4 | 4 |
| +1.2 w/w % “A” | 1 | 0 | 0 | 0 | 0 | 0 | 1 | 0 | 0 | 1 | 0 | 0 |
| +1.6 w/w % “A” | 0 | 0 | 0 | 0 | 0 | 0 | 0 | 0 | 0 | 0 | 0 | 0 |
| +0.4 w/w % “B” | 4 | 3 | 4 | 4 | 4 | 4 | 4 | 4 | 4 | 4 | 4 | 4 |
| +0.8 w/w % “B” | 0 | 0 | 0 | 0 | 0 | 0 | 2 | 1 | 0 | 2 | 2 | 0 |
| +1.2 w/w % “B” | 0 | 0 | 0 | 0 | 0 | 0 | 0 | 0 | 0 | 0 | 0 | 0 |
| +1.6 w/w % “B” | 0 | 0 | 0 | 0 | 0 | 0 | 0 | 0 | 0 | 0 | 0 | 0 |
| +0.4 w/w % “C” | 4 | 4 | 4 | 4 | 4 | 4 | 4 | 4 | 4 | 4 | 4 | 4 |
| +0.8 w/w % “C” | 4 | 4 | 4 | 4 | 4 | 4 | 4 | 4 | 4 | 4 | 4 | 4 |
| +1.2 w/w % “C” | 4 | 4 | 4 | 4 | 4 | 4 | 4 | 4 | 4 | 4 | 4 | 4 |
| +1.6 w/w % “C” | 4 | 4 | 4 | 4 | 4 | 4 | 4 | 4 | 4 | 4 | 4 | 4 |
| +0.4 w/w % “D” | 4 | 4 | 4 | 4 | 4 | 4 | 4 | 4 | 4 | 4 | 4 | 4 |
| +0.8 w/w % “D” | 3 | 2 | 0 | 3 | 2 | 2 | 3 | 2 | 3 | 3 | 3 | 2 |
| +1.2 w/w % “D” | 1 | 0 | 0 | 0 | 0 | 0 | 0 | 0 | 0 | 1 | 0 | 0 |
| +1.6 w/w % “D” | 0 | 0 | 0 | 0 | 0 | 0 | 0 | 0 | 0 | 0 | 0 | 0 |
| Interior Paint #1 | 4 | 4 | 4 | 4 | 4 | 4 | 4 | 4 | 4 | 4 | 4 | 4 |
| +0.4 w/w % “A” | 4 | 4 | 4 | 4 | 4 | 4 | 4 | 4 | 4 | 4 | 4 | 4 |
| +0.8 w/w % “A” | 4 | 4 | 4 | 4 | 4 | 4 | 4 | 4 | 4 | 4 | 4 | 4 |
| +1.2 w/w % “A” | 3 | 3 | 4 | 4 | 4 | 4 | 4 | 4 | 4 | 4 | 4 | 4 |
| +1.6 w/w % “A” | 2 | 0 | 0 | 3 | 3 | 2 | 3 | 3 | 2 | 3 | 4 | 2 |
| +0.4 w/w % “B” | 4 | 3 | 4 | 4 | 4 | 4 | 4 | 4 | 4 | 4 | 4 | 4 |
| +0.8 w/w % “B” | 4 | 3 | 0 | 3 | 3 | 0 | 3 | 3 | 0 | 3 | 3 | 0 |
| +1.2 w/w % “B” | 3 | 0 | 0 | 3 | 0 | 0 | 3 | 1 | 0 | 3 | 2 | 0 |
| +1.6 w/w % “B” | 0 | 0 | 0 | 0 | 0 | 0 | 2 | 0 | 0 | 3 | 1 | 0 |
| +0.4 w/w % “C” | 4 | 4 | 4 | 4 | 4 | 4 | 4 | 4 | 4 | 4 | 4 | 4 |
| +0.8 w/w % “C” | 4 | 4 | 4 | 4 | 4 | 4 | 4 | 4 | 4 | 4 | 4 | 4 |
| +1.2 w/w % “C” | 4 | 4 | 4 | 4 | 4 | 4 | 4 | 4 | 4 | 4 | 4 | 4 |
| +1.6 w/w % “C” | 4 | 4 | 4 | 4 | 4 | 4 | 4 | 4 | 4 | 4 | 4 | 4 |
| +0.4 w/w % “D” | 4 | 4 | 4 | 4 | 4 | 4 | 4 | 4 | 4 | 4 | 4 | 4 |
| +0.8 w/w % “D” | 4 | 4 | 3 | 4 | 4 | 3 | 4 | 4 | 3 | 4 | 4 | 3 |
| +1.2 w/w % “D” | 4 | 3 | 3 | 4 | 3 | 3 | 4 | 4 | 3 | 4 | 4 | 3 |
| +1.6 w/w % “D” | 3 | 3 | 2 | 3 | 3 | 2 | 3 | 3 | 2 | 3 | 3 | 2 |

TABLE A4
Bacterial challenge data for formulation “1721-52” (10% IPBC,
5% ZnO, 60% 1,2-hexanediol) in Interior Paint #2.

| | Days after Bacterial Challenge | | | | | | | | | | |
|---|---|---|---|---|---|---|---|---|---|---|---|
| | Week 1 | | | Week 2 | | | Week 3 | | Week 4 | | |
| Test Sample | 1 | 2 | 7 | 1 | 2 | 7 | 1 | 7 | 1 | 2 | 7 |
| Interior Paint #2 | 4 | 4 | 4 | 4 | 4 | 4 | 4 | 4 | 4 | 4 | 4 |
| +0.50 w/w % “1721-52” | 4 | 4 | 1 | 4 | 3 | 4 | 4 | 4 | 4 | 4 | 4 |
| +0.75 w/w % “1721-52” | 4 | 3 | 0 | 4 | 3 | 0 | 3 | 0 | 4 | 3 | 0 |
| +1.00 w/w % “1721-52” | 4 | 3 | 0 | 4 | 3 | 0 | 3 | 0 | 3 | 3 | 0 |
| +1.25 w/w % “1721-52” | 4 | 3 | 0 | 4 | 3 | 0 | 3 | 0 | 3 | 3 | 0 |
| +1.50 w/w % “1721-52” | 4 | 2 | 0 | 4 | 3 | 0 | 3 | 0 | 3 | 3 | 0 |

TABLE A5
Fungal challenge data for formulation “1721-52” (10% IPBC,
5% ZnO, 60% 1,2-hexanediol) in Interior Paint #2.

| | 7 Days After Fungal Challenge | | | |
|---|---|---|---|---|
| Test Sample | Week 1 | Week 2 | Week 3 | Week 4 |
| Interior Paint #2 | 4 | 4 | 4 | 4 |
| +0.50 w/w % “1721-52” | 0 | 0 | 0 | 0 |
| +0.75 w/w % “1721-52” | 0 | 0 | 0 | 0 |
| +1.00 w/w % “1721-52” | 0 | 0 | 0 | 0 |
| +1.25 w/w % “1721-52” | 0 | 0 | 0 | 0 |
| +1.50 w/w % “1721-52” | 0 | 0 | 0 | 0 |

TABLE A6
Dry-film challenge data for formulation “1721-52” (10% IPBC,
5% ZnO, 60% 1,2-hexanediol) in Interior Paint #2.

| | | Fungal Coverage After 4 Weeks | |
|---|---|---|---|
| | IPBC, | Aureobasidium | Aspergillus niger/ |
| Test Sample | ppm | pullulans | P. funiculosum |
| Interior Paint #2 | 0 | 0 | 3 |
| +0.50 w/w % “1721-52” | 500 | 0 | 3 |
| +0.75 w/w % “1721-52” | 750 | 0 | 0 |
| +1.00 w/w % “1721-52” | 1000 | 0 | 0, z-3 |
| +1.25 w/w % “1721-52” | 1250 | 0, z-3 | 0, z-7 |
| +1.50 w/w % “1721-52” | 1500 | 0, z-8 | 0, z-8 |
| +0.40 w/w % Polyphase | 600 | 0, z(5) | 0, z(9) |
| P20T | | | |

TABLE A7
Bacterial challenge data for formulation “1721-66” (10% IPBC, 5% ZnO,
60% 1,2-hexanediol) in three colorants. “1721-66” is chemically identical to “1721-52.”

| | Days after Bacterial Challenge | | | | | | | | | | | |
|---|---|---|---|---|---|---|---|---|---|---|---|---|
| | Week 1 | | | Week 2 | | | Week 3 | | | Week 4 | | |
| Test Sample | 1 | 2 | 7 | 1 | 2 | 7 | 1 | 2 | 7 | 1 | 2 | 7 |
| Colorant (Black) | 4 | 3 | 4 | 4 | 4 | 4 | 4 | 4 | 4 | 4 | 4 | 4 |
| +0.8 w/w % “1721-66” | 0 | 0 | 0 | 1 | 0 | 0 | 3 | 0 | 0 | 3 | 2 | 0 |
| +1.0 w/w % “1721-66” | 0 | 0 | 0 | 0 | 0 | 0 | 1 | 0 | 0 | 3 | 1 | 0 |
| +1.2 w/w % “1721-66” | 0 | 0 | 0 | 0 | 0 | 0 | 0 | 0 | 0 | 1 | 0 | 0 |
| +1.4 w/w % “1721-66” | 0 | 0 | 0 | 0 | 0 | 0 | 0 | 0 | 0 | 0 | 0 | 0 |
| +1.8 w/w % “1721-66” | 0 | 0 | 0 | 0 | 0 | 0 | 0 | 0 | 0 | 0 | 0 | 0 |
| +2.0 w/w % “1721-66” | 0 | 0 | 0 | 0 | 0 | 0 | 0 | 0 | 0 | 0 | 0 | 0 |
| Colorant (Red) | 4 | 3 | 0 | 4 | 3 | 0 | 4 | 3 | 2 | 4 | 4 | 3 |
| +0.8 w/w % “1721-66” | 3 | 0 | 0 | 1 | 0 | 0 | 3 | 0 | 0 | 3 | 3 | 0 |
| +1.0 w/w % “1721-66” | 0 | 0 | 0 | 0 | 0 | 0 | 2 | 0 | 0 | 3 | 0 | 0 |
| +1.2 w/w % “1721-66” | 0 | 0 | 0 | 0 | 0 | 0 | 1 | 0 | 0 | 3 | 0 | 0 |
| +1.4 w/w % “1721-66” | 0 | 0 | 0 | 0 | 0 | 0 | 0 | 0 | 0 | 2 | 0 | 0 |
| +1.8 w/w % “1721-66” | 0 | 0 | 0 | 0 | 0 | 0 | 0 | 0 | 0 | 0 | 0 | 0 |
| +2.0 w/w % “1721-66” | 0 | 0 | 0 | 0 | 0 | 0 | 0 | 0 | 0 | 0 | 0 | 0 |

TABLE A8
Fungal challenge data for formulation “1721-66” (10%
IPBC, 5% ZnO, 60% 1,2-hexanediol) in three colorants.

| | 7 Days After Fungal Challenge | | | |
|---|---|---|---|---|
| Test Sample | Week 1 | Week 2 | Week 3 | Week 4 |
| Colorant (Black) | 4 | 4 | 4 | 4 |
| +0.8 w/w % “1721-66” | 0 | 0 | 0 | 0 |
| +1.0 w/w % “1721-66” | 0 | 0 | 0 | 0 |
| +1.2 w/w % “1721-66” | 0 | 0 | 0 | 0 |
| +1.4 w/w % “1721-66” | 0 | 0 | 0 | 0 |
| +1.8 w/w % “1721-66” | 0 | 0 | 0 | 0 |
| +2.0 w/w % “1721-66” | 0 | 0 | 0 | 0 |
| Colorant (Red) | 4 | 4 | 4 | 4 |
| +0.8 w/w % “1721-66” | 0 | 0 | 0 | 0 |
| +1.0 w/w % “1721-66” | 0 | 0 | 0 | 0 |
| +1.2 w/w % “1721-66” | 0 | 0 | 0 | 0 |
| +1.4 w/w % “1721-66” | 0 | 0 | 0 | 0 |
| +1.8 w/w % “1721-66” | 0 | 0 | 0 | 0 |
| +2.0 w/w % “1721-66” | 0 | 0 | 0 | 0 |

TABLE A9
Bacterial challenge data for additional solvents
to rescue IPBC/ZnO activity in Interior Paint #5.

| | | Days After Bacterial Challenge | | | | | | | | | | | |
|---|---|---|---|---|---|---|---|---|---|---|---|---|---|
| | | Week 1 | | | Week 2 | | | Week 3 | | | Week 4 | | |
| Test Sample | # | 1 d | 2 d | 7 d | 1 d | 2 d | 7 d | 1 d | 2 d | 7 d | 1 d | 2 d | 7 d |
| Interior Paint #5 | 1 | 4 | 4 | 4 | 4 | 4 | 4 | 4 | 4 | 4 | 4 | 4 | 4 |
| 1 + 800 ppm IPBC + | 1.1 | 3 | 3 | 3 | 4 | 3 | 3 | 3 | 3 | 4 | 4 | 4 | 4 |
| 400 ppm ZnO | | | | | | | | | | | | | |
| 1.1 + 0.5% Hexyl Carbitol | 1.2 | 2 | 2 | 0 | 2 | 1 | 0 | 2 | 2 | 0 | 3 | 2 | 0 |
| 1.1 + 0.5% TPnB Glycol | 1.3 | 3 | 3 | 2 | 3 | 3 | 2 | 3 | 3 | 2 | 3 | 3 | 2 |
| Ether | | | | | | | | | | | | | |
| 1.1 + 0.5% Butoxytriglycol | 1.4 | 3 | 3 | 2 | 3 | 3 | 2 | 3 | 3 | 3 | 3 | 3 | 3 |
| 1.1 + 0.5% Triacetin | 1.5 | 3 | 3 | 3 | 4 | 3 | 4 | 4 | 4 | 3 | 4 | 4 | 4 |
| 1.1 + 0.5% 1,2-Hexanediol | 1.6 | 3 | 3 | 1 | 3 | 3 | 1 | 3 | 3 | 1 | 3 | 3 | 1 |

TABLE A10
Bacterial challenge results for glycol ether, vicinal diol, and alcohol ester
(Texanol) ability to boost IPBC/ZnO antibacterial activity in paint. To perform
the test, IPBC/ZnO was loaded into paint and divided into several subsamples.
Candidate solvents were added back to the IPBC/ZnO dosed paint at 0.5% w/w, and
also tested for activity on their own at 0.5% w/w. The inoculum utilized was the
Troy Industrial Inoculum (~10⁷ CFU/g per challenge).

| | | Days After Bacterial Challenge | | | | | | | | | |
|---|---|---|---|---|---|---|---|---|---|---|---|
| | | Week 1 | | Week 2 | | Week 3 | | | Week 4 | | |
| Test Sample | # | 1 d | 7 d | 1 d | 7 d | 1 d | 2 d | 7 d | 1 d | 2 d | 7 d |
| Interior Paint #5 | 1 | 4 | 4 | 4 | 4 | 4 | 4 | 4 | 4 | 4 | 4 |
| 1 + 800 ppm IPBC + | 1.1 | 3 | 4 | 4 | 2 | 4 | 4 | 3 | 4 | 4 | 4 |
| 400 ppm ZnO | | | | | | | | | | | |
| 1.1 + 0.5% 1,2- | 1.2 | 2 | 0 | 3 | 1 | 3 | 3 | 0 | 3 | 2 | 0 |
| Hexanediol | | | | | | | | | | | |
| 1.1 + 0.5% Hexyl | 1.3 | 0 | 0 | 0 | 0 | 2 | 0 | 0 | 1 | 0 | 0 |
| Carbitol | | | | | | | | | | | |
| 1.1 + 0.5% Hexyl | 1.4 | 0 | 0 | 0 | 4 | 0 | 0 | 0 | 0 | 0 | 0 |
| CELLOSOLVE | | | | | | | | | | | |
| 1.1 + 0.5% Butyl | 1.5 | 2 | 0 | 3 | 2 | 3 | 3 | 2 | 3 | 3 | 1 |
| CELLOSOLVE | | | | | | | | | | | |
| 1.1 + 0.5% | 1.6 | 3 | 3 | 3 | 4 | 3 | 3 | 4 | 4 | 4 | 4 |
| Ethoxytriglycol | | | | | | | | | | | |
| 1.1 + 0.5% D-EPh6 | 1.7 | 3 | 2 | 3 | 3 | 3 | 4 | 4 | 4 | 4 | 4 |
| Glycol Ether | | | | | | | | | | | |
| 1.1 + 0.5% UCAR ™ | 1.8 | 3 | 0 | 3 | 3 | 3 | 4 | 4 | 4 | 4 | 4 |
| Filmer IBT | | | | | | | | | | | |
| 1.1 + 0.5% D-LoV 485 | 1.9 | 3 | 2 | 3 | 3 | 4 | 4 | 4 | 4 | 4 | 4 |
| Glycol Ether | | | | | | | | | | | |
| 1.1 + 0.5% TPnB Glycol | 1.10 | 3 | 2 | 3 | 3 | 4 | 4 | 4 | 4 | 4 | 4 |
| Ether | | | | | | | | | | | |
| 1.1 + 0.5% PnP Glycol | 1.11 | 3 | 2 | 3 | 2 | 3 | 3 | 2 | 3 | 3 | 2 |
| ether | | | | | | | | | | | |
| 1.1 + 0.5% | 1.12 | 3 | 1 | 3 | 4 | 4 | 4 | 4 | 4 | 4 | 4 |
| Butoxytriglycol | | | | | | | | | | | |
| 1.1 + 0.50% Arcosolv | 1.13 | 3 | 2 | 3 | 2 | 3 | 3 | 2 | 3 | 3 | 2 |
| PnB | | | | | | | | | | | |
| 1.1 + 0.50% Texanol | 1.14 | 2 | 0 | 3 | 2 | 3 | 4 | 4 | 4 | 4 | 4 |
| 1.1 + 0.50% 1,2- | 1.15 | 0 | 0 | 0 | 0 | 0 | 0 | 0 | 0 | 0 | 0 |
| Octanediol | | | | | | | | | | | |
| 1 + 0.5% 1,2- | 1.16 | 3 | 3 | 4 | 3 | 3 | 3 | 3 | 3 | 4 | 3 |
| Hexanediol | | | | | | | | | | | |
| 1 + 0.5% Hexyl Carbitol | 1.17 | 4 | 4 | 4 | 3 | 3 | 3 | 3 | 4 | 4 | 3 |
| 1 + 0.5% Hexyl | 1.18 | 2 | 0 | 3 | 4 | 4 | 4 | 4 | 4 | 4 | 4 |
| CELLOSOLVE | | | | | | | | | | | |
| 1 + 0.5% Butyl | 1.19 | 3 | 4 | 4 | 4 | 4 | 4 | 4 | 4 | 4 | 4 |
| CELLOSOLVE | | | | | | | | | | | |
| 1+0.5% | 1.20 | 4 | 4 | 4 | 4 | 4 | 4 | 4 | 4 | 4 | 4 |
| Ethoxytriglycol | | | | | | | | | | | |
| 1 + 0.5% D-EPh6 | 1.21 | 4 | 4 | 4 | 4 | 4 | 4 | 4 | 4 | 4 | 4 |
| Glycol Ether | | | | | | | | | | | |
| 1 + 0.5% UCAR ™ | 1.22 | 4 | 4 | 4 | 4 | 4 | 4 | 4 | 4 | 4 | 4 |
| Filmer IBT | | | | | | | | | | | |
| 1 + 0.5% D-LoV 485 | 1.23 | 4 | 4 | 4 | 4 | 4 | 4 | 4 | 4 | 4 | 4 |
| Glycol Ether | | | | | | | | | | | |
| 1 + 0.5% TPnB Glycol | 1.24 | 4 | 4 | 4 | 4 | 4 | 4 | 4 | 4 | 4 | 4 |
| Ether | | | | | | | | | | | |
| 1 + 0.5% PnP Glycol | 1.25 | 4 | 4 | 4 | 4 | 4 | 4 | 4 | 4 | 4 | 4 |
| ether | | | | | | | | | | | |
| 1 + 0.5% | 1.26 | 4 | 4 | 4 | 2 | 4 | 4 | 4 | 4 | 4 | 4 |
| Butoxytriglycol | | | | | | | | | | | |
| 1 + 0.50% Arcosolv | 1.27 | 3 | 4 | 4 | 4 | 3 | 4 | 4 | 4 | 4 | 4 |
| PnB | | | | | | | | | | | |
| 1 + 0.50% Texanol | 1.28 | 4 | 4 | 4 | 4 | 4 | 4 | 4 | 4 | 4 | 4 |
| 1 + 0.50% 1,2- | 1.29 | 1 | 0 | 2 | 4 | 2 | 0 | 0 | 2 | 1 | 0 |
| Octanediol | | | | | | | | | | | |

TABLE A11
Bacterial challenge results for “1750-8” at 0.6-1.2% w/w in paint.
The inoculum utilized was the Troy Industrial Inoculum (~10⁷ CFU/g per challenge).

| | | Days After Bacterial Challenge | | | | | | | | | | | |
|---|---|---|---|---|---|---|---|---|---|---|---|---|---|
| | | Week 1 | | | Week 2 | | | Week 3 | | | Week 4 | | |
| Test Sample | # | 1 d | 2 d | 7 d | 1 d | 2 d | 7 d | 1 d | 2 d | 7 d | 1 d | 2 d | 7 d |
| Interior Paint #5 | 1 | 4 | 4 | 4 | 4 | 4 | 4 | 4 | 4 | 4 | 4 | 4 | 4 |
| +0.6% “1750-8” | 1.1 | 3 | 3 | 1 | 3 | 3 | 2 | 4 | 3 | 2 | 3 | 2 | 1 |
| +0.8% “1750-8” | 1.2 | 1 | 1 | 0 | 3 | 2 | 0 | 3 | 2 | 0 | 3 | 2 | 1 |
| +1.0% “1750-8” | 1.3 | 1 | 1 | 0 | 2 | 1 | 0 | 2 | 2 | 0 | 2 | 1 | 0 |
| +1.2% “1750-8” | 1.4 | 1 | 0 | 0 | 0 | 0 | 0 | 2 | 0 | 0 | 0 | 0 | 0 |

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the disclosure so further described in such appended claims.

1. A biocidal composition, comprising an antibacterially effective combination of IPBC and zinc oxide.

2. The biocidal composition of claim 1, wherein the IPBC and zinc oxide are present in a weight ratio of 25:1 to 1:25.

3. The biocidal composition of claim 1, wherein the zinc oxide comprises zinc oxide nanoparticles.

4. The biocidal composition of claim 1, further comprising one or more bacterial membrane disrupting substances.

5. The biocidal composition of claim 4, wherein the one or more bacterial membrane disrupting substances comprise one or more vicinal diols.

6. The biocidal composition of claim 4, wherein the one or more bacterial membrane disrupting substances comprise 1,2-hexanediol.

7. The biocidal composition according to claim 4, wherein the one or more bacterial membrane disrupting substances comprise one or more glycol ethers.

8. The biocidal composition of claim 4, wherein the one or more bacterial membrane disrupting substances comprise hexyl carbitol, TPnB glycol ether, butoxytrigycol, or triacetin.

9. The biocidal composition of claim 1, further comprising one or more additional biocidal substances.

10. The biocidal composition of claim 9, wherein the one or more additional biocidal substances comprise one or more antifungal substances and/or one or more algaecidal substances.

11. The biocidal composition of claim 5, comprising 1% to 25% by weight IPBC, 1% to 25% by weight zinc oxide, and 40% to 80% by weight of one or more vicinal diols.

12. The biocidal composition of claim 11, comprising 10% by weight IPBC, 5% by weight zinc oxide, and 60% by weight of the one or more vicinal diols.

13. The biocidal composition of claim 7, comprising 1% to 25% by weight IPBC, 1% to 25% by weight zinc oxide, and 40% to 80% by weight of the one or more glycol ethers.

14. The biocidal composition of claim 13, comprising about 10% by weight IPBC, about 5% by weight zinc oxide, and about 60% by weight of the one or more glycol ethers.

15-31. (canceled)

32. A method of enhancing antibacterial activity of IPBC in a wet-state working composition comprising water and one or more organic compounds, comprising treating the working composition with IPBC in the presence of zinc oxide.

33. The method of claim 32, wherein the IPBC and zinc oxide are present in a weight ratio of 25:1 to 1:25.

34. The method of claim 32, wherein the zinc oxide comprises zinc oxide nanoparticles.

35. The method of claim 32, wherein the working composition is further treated with one or more bacterial membrane disrupting substances.

36. The method of claim 35, wherein the one or more bacterial membrane disrupting substances comprise one or more vicinal diols.

37. The method of claim 36, wherein the one or more vicinal diols comprise 1,2-hexanediol.

38-62. (canceled)
